(19) United States
(12) Patent Application Publication
(10) Pub. No.: US 2011/0171119 A1
(43) Pub. Date: Jul. 14, 2011

(54) HYDROGEN STORAGE AND/OR GENERATION

(76) Inventor: Rachid YAZAMI, Singapore (SG)

(21) Appl. No.: 12/968,274

(22) Filed: Dec. 14, 2010

Related U.S. Application Data
(60) Provisional application No. 61/286,104, filed on Dec. 14, 2009.

(51) Int. Cl. C01B 3/00; C01B 3/08; C09K 3/00

(52) U.S. Cl. 423/657; 423/648.1; 252/184

(57) ABSTRACT

Hydrogen storage and/or generation arrangements and compositions comprising an electron donor and an electron acceptor in a suitable solvent and related methods and systems to store and/or generate hydrogen.

### CROSS REFERENCE TO RELATED APPLICATIONS

The present application claims priority to U.S. Provisional Application No. 61/286,104, filed on Dec. 14, 2009, which is incorporated herein by reference in its entirety.

### FIELD

The present disclosure relates to hydrogen storage and/or generation and to related arrangements compositions methods and systems.

### BACKGROUND

Hydrogen can be stored in solid state materials such as carbonaceous materials and other high porosity or metal alloy materials.

In particular, most materials suitable to store hydrogen require high pressure and low temperatures for the hydrogen storage. Hydrogen can then be typically generated from storage materials by heat or by chemical reactions.

### SUMMARY

Provided herein are arrangements, devices, compositions, methods, and systems for the storage and/or release of hydrogen which in several embodiments provide an efficient manner in which hydrogen can be stored and/or released.

According to a first aspect, a hydrogen storage arrangement and a device comprising the arrangement are described. The hydrogen storage arrangement comprises an electron donor and an electron acceptor provided in a solvent. In the hydrogen storage arrangement, the electron donor comprises an electron donor metal which comprises an alkali metal, an alkali earth metal, a lanthanide metal, a metal of the boron group, a metalloid and/or an alloy thereof, and the electron acceptor comprises an organo radical and/or a polycyclic aromatic hydrocarbon. In the hydrogen storage arrangement, at least a portion of the electron donor comprising the electron donor metal is dissolved in the solvent, thereby generating chemical species capable of reacting with hydrogen to store hydrogen in the solvent. In some embodiments, the hydrogen storage arrangement further comprises hydrogen which reacts with the chemical species in the arrangement to form a metal hydride organic complex. The hydrogen storage arrangement can be comprised in a suitable hydrogen storage device.

According to a second aspect a method to store hydrogen in a hydrogen storage arrangement and a hydrogen storage arrangement obtainable thereby are described. The method comprises contacting hydrogen with a hydrogen storage arrangement comprising an electron donor and an electron acceptor provided in a solvent herein described wherein the arrangement comprises chemical species capable to react with hydrogen. In the method the contacting is performed for a time and under condition to allow reaction of the hydrogen with the chemical species to store hydrogen in the arrangement.

According to a third aspect a method to release hydrogen from a hydrogen storage arrangement is described. The method comprises providing a hydrogen storage arrangement herein described that comprises hydrogen herein described at a hydrogen storage arrangement pressure and decreasing the hydrogen storage arrangement pressure to release hydrogen.

According to a fourth aspect a method to store hydrogen in a suitable solvent and the solution obtainable thereby are described. The method comprises contacting hydrogen with a solvent for a time and under condition to allow reaction of the hydrogen with the solvent. In the method the solvent is capable to dissolve at least a portion of an electron donor comprising an electron donor metal in a solution further comprising an electron acceptor, wherein the electron donor comprises an electron donor metal which comprises an alkali metal, an alkali earth metal, a lanthanide metal, a metal of the boron group, a metalloid and/or an alloy thereof, and the electron acceptor comprises a polycyclic aromatic hydrocarbon and/or an organo radical.

According to a fifth aspect, a method to release hydrogen from a solution is described. The method comprises providing a solutions comprising hydrogen herein described at a starting pressure and decreasing the starting pressure to release hydrogen.

According to a sixth aspect, a hydrogen generating arrangement and a hydrogen generator are described. The hydrogen generating arrangement comprises an electron donor and an electron acceptor herein described provided in a solvent herein described. In the hydrogen generating arrangement the electron donor metal and the electron acceptor are capable to react with water or an organic molecule comprising a labile proton to generate hydrogen.

According to a seventh aspect, a method and system to generate hydrogen is provided. The method comprises contacting a hydrogen generating arrangement herein described with a compound comprising a labile proton, the contacting performed for a time and under condition to allow reaction of the electron donor metal and the electron acceptor with the compound comprising a labile proton to generate hydrogen. The system comprises at least two of an electron donor and an electron acceptor herein described provided in a solvent herein described; and one or more compounds comprising a labile proton for simultaneous combined or sequential use in the method herein described.

According to an eight aspect, a method and system to provide a hydrogen storage and/or generating arrangement are described. The method comprises: contacting an electron donor and an electron acceptor herein described in a solvent herein described. In the method, the contacting is performed to allow at least a portion of the electron donor comprising the electron donor metal to be dissolved in the solvent, thereby generating chemical species capable of reacting with hydrogen to store hydrogen in the solvent or reacting with a compound comprising a labile proton to generate hydrogen. In some embodiments the method further comprises contacting the chemical species with hydrogen to form a metal hydride complex within the solvent and/or the arrangement. The system comprises an electron donor an electron acceptor and a solvent herein described, for simultaneous combined or sequential use in the method to provide a hydrogen storage and/or generating system herein described.

The arrangement, compositions, devices, methods and systems herein described can be used in connection with applications wherein hydrogen storage and/or generation are desired. Exemplary applications comprise fuels, and in particular fuel cells, batteries, and in particular compact energy carrier for mobile applications and additional applications associated to the so called hydrogen economy, including hydrogen-on-demand systems, which are identifiable by a skilled person. Additional applications comprise industrial processes in which hydrogen is produced as a result of chemical reactions (e.g. involving Chlorine) wherein hydrogen storage to store the produced hydrogen is desired.

The details of one or more embodiments of the disclosure are set forth in the accompanying drawings and the description below. Other features, objects, and advantages will be apparent from the description and drawings, and from the claims.

### BRIEF DESCRIPTION OF THE DRAWINGS

The accompanying drawings, which are incorporated into and constitute a part of this specification, illustrate one or more embodiments of the present disclosure and, together with the detailed description and the examples, serve to explain the principles and implementations of the disclosure.

FIG. 1 shows a schematic representation of an exemplary system to store hydrogen in SES according to an embodiment herein described. Hydrogen is stored in a tank (100). Hydrogen is allowed into the system through a valve (150) and the pressure of the hydrogen into the system is measured by a baratron (140) that is connected to a valve (155) to the outside air. Up to 300 ml of Hydrogen can be stored in a containment space (160). A pressure container (110) contains SES. Valves (170) and (180) allow hydrogen to enter the pressure container. A baratron (130) measures changes in pressure in the pressure container. A valve (190) allows collection of the SES into a collection apparatus (120).

FIG. 2 shows a diagram illustrating hydrogen storage performed according to an embodiment herein described. In particular the hydrogen uptake (y axis, wt %) relative to pressure (atm) for hydrogen in THF (210), hydrogen in THF-Naphtalene-K (220), and hydrogen in THF-Naphtalene-Li (230) is reported.

FIG. 3 shows a schematic representation of a hydrogen storage and generation reactor with a hydrogen selective permeable membrane according to an embodiment herein described.

FIG. 4 shows a schematic representation of a hydrogen generation reactor with a hydrogen selective permeable membrane according to an embodiment herein described.

### DETAILED DESCRIPTION

Arrangements, devices, compositions, methods, and systems for the storage and/or release of hydrogen are described, which are based in several embodiments, on electron donors and electron acceptors provided in a solvent and/or the solvent alone.

The term “electron donor” refers to a reducing agent. The terms “reducing agent” and “reduction agent” refer to a material, which reacts with a material and causes the material to gain electron(s) and/or decreases the oxidation state of the material. The class in which the electron donor donates an electron to is referred to as an electron acceptor.

The term “electron acceptor” refers to an oxidizing agent. The terms “oxidation agent” and “oxidizing agent” refer to a material, which reacts with a material and causes the material to lose electron(s) and/or increases the oxidation state of the material. The class in which the electron acceptor accepts an electron from is referred to as an electron donor.

The term “solvent” as used herein refers to a liquid, solid, or gas that dissolves a solid, liquid, or gaseous solute, resulting in a solution. Liquid solvents can dissolve electron acceptors (such as polycyclic aromatic hydrocarbons) and electron donor metals in order to facilitate the transfer of electrons from the electron donor metal to the electron acceptor. Solvents are particularly useful in soluble hydrogen storage arrangements of the present disclosure for dissolving electron donor metals and electron acceptors to form electron donor metal ions and solvated electrons in the solvent. Solvents include “organic solvents” which are solvents comprising organic molecules. In some embodiments, the solvents are liquid solvents. Hydrogen is expected to diffuse faster in a liquid solution than in a solid state crystal. In some embodiments, diffusion can be even faster if the liquid solution is stirred, shaken, sonicated or irradiated to increase the contact surface with hydrogen gas, unlike a rigid structure solid.

In arrangements, compositions, devices, methods and systems herein described, the electron donor comprises an electron donor metal. The term “electron donor metal” refers to a metal which transfers one or more electrons to another. Electron donor metals herein described include, but are not limited to, alkali metals, alkali earth metals, and lanthanide metals (also known as lanthanoid metals). The term “alkali metal” as used herein refers to chemical elements forming Group 1 (IUPAC style) of the periodic table which include: lithium (Li), sodium (Na), potassium (K) rubidium (Rb), caesium (Cs), and francium (Fr). The term “alkali-earth metal” refers to chemical elements forming Group 2 (IUPAC style) of the periodic table: beryllium (Be), magnesium (Mg), calcium (Ca), strontium (Sr), barium (Ba), and radium (Ra). The term “lanthanide metals” as used herein refers to the fifteen elements with atomic numbers 57 through 71, from lanthanum to lutetium.

Electron donor metals herein described also include, but are not limited to metal of the Boron group (Group 13) which comprise boron (B), aluminum (Al), gallium (Ga), indium (In) and metalloids (elements of Group 14), such as germanium, silicon, and carbon and additional metalloids identifiable by a skilled person.

In an embodiment, the electron donor can comprise one or more electron donor metal from the same or different Group or Groups of the periodic table of the elements in combinations identifiable by a skilled person. In particular, in an embodiment, the electron donor metal can comprise one or more alkali metal, alkali earth metal, lanthanide metals, metals of the boron group, metalloids or mixture thereof identifiable by a skilled person.

In arrangements, compositions, devices, methods and systems herein described, the electron acceptor comprises a polycyclic aromatic hydrocarbon and/or an organo radical.

The term “polycyclic aromatic hydrocarbon” (abbreviated “PAH”) refers to a hydrocarbon which contains two or more aromatic rings. Rings in a polycyclic aromatic hydrocarbon are in the form of a hexagon (six-sided ring), a pentagon (five-sided ring), a tetragon (four-sided ring) and a triangle (three-sided ring). The total number of rings in certain polycyclic aromatic hydrocarbon in this application is in the range 2-200, more particularly in the range 2-100, more particularly in the range 2-50, more particularly in the range 2-20 and even more particularly in the range 2-10. Polycyclic aromatic hydrocarbons herein described can act as electron acceptors.

In an embodiment, polycyclic aromatic hydrocarbons (PAH) can comprise one or more heterocyclic rings and heteroatom substitutions. Substitution of carbon atoms with one or more of Si, B or N affects the electronic structure of the PAH and its properties as electron acceptor. It is expected that PAH comprising Si—, B— and N— and in particular polycyclic aromatic hydrocarbon substituted PAHs have enhanced solvated electron formation capability, thus favoring hydrogen storage.

In some embodiments, PAH herein described can have the general formula of general formula: Cₐ₍₁₋ₓ₎AₐₓH_{b}, (I) wherein A is Si, B and/or N, 0.005<x<0.9, a and b are stoichiometric coefficients. In some of those embodiments, wherein the PAH is a compound of Formula (I) x can be 0.01-0.75, more particularly 0.05-0.50 and even more particularly 0.1-0.3. In some of those embodiments, wherein the PAH is a compound of Formula (I) the molar ratio H/C=b/a can be 0-0.8, more particularly 0.05-0.75 and even more particularly 0.1-0.5.

Polycyclic aromatic hydrocarbons include, but are not limited to, graphene, fullerenes (e.g. C60, C70, etc.), Azulene, Naphthalene, 1-Methylnaphthalene, Acenaphthene, Acenaphthylene, Anthracene, Fluorene, Phenalene, Phenanthrene, Benzo[a]anthracene, Benzo[a]phenanthrene, Chrysene, Fluoranthene, Pyrene, Tetracene, Triphenylene Anthanthrene, Benzopyrene, Benzo[a]pyrene, Benzo[e]fluoranthene, Benzo[ghi]perylene, Benzo[j]fluoranthene, Benzo[k]fluoranthene, Corannulene, Coronene, Dicoronylene, Helicene, Heptacene, Hexacene, Ovalene, Pentacene, Picene, Perylene, and Tetraphenylene. Derivatives of the above PAHs, including those achieved by substituting hydrogen in formula (I) by an organic radical such as, but not limited to, an alkyl group and/or by an organic functional group such as, but not limited to, an alcohol group, an acid group, a ketone group, an amine group are also applicable to hydrogen storage and generation of the present invention.

The term “organo radical” or “organic radical” refers to an organic molecule having an unpaired electron. Organo radicals can be provided to a solution or a solvent in the form of a halide analogue of the organo radical. Organo radicals include alkyl radicals which can be provided to a solution or solvent as an alkyl halide. Organo radicals can react via a charge transfer, partial electron transfer, or full electron transfer reaction with an electron donor metal to form an organometallic reagent. Organo radicals can act as electron acceptors. The term “organometallic reagent” refers to a compound with one or more direct bonds between a carbon atom and an electron donor metal. Organo radicals include, but are not limited to, butyl, ethyl, methyl, phenyl and acetyl radicals. Organo radicals can be present as mono radical (such as in butyl-lithium) or as multiple radical (such as in diphenyl-lithium and in ethyl-methyl-lithium) identifiable by a skilled person.

In an embodiment, the electron acceptor can comprise one or more PAH, and in particular a PAH of formula (I), and/or one or more organo radicals in combinations identifiable by a skilled person.

In arrangements, compositions, devices, methods and systems herein described, at least a portion of the electron donor comprising the electron donor metal is dissolved in the solvent, thereby generating chemical species capable of reacting with hydrogen to store and/or generate hydrogen in the solvent. In particular, in embodiments wherein the electron acceptor is a polycyclic aromatic hydrocarbon, the chemical species comprise a metal ion and a solvated electron. In embodiments, wherein the electron acceptor is an organo radical the chemical species comprises an organometal.

In some embodiments, the arrangements, compositions, devices methods and systems herein described can further include one or more catalyst for hydrogen storage and generation. The term “catalyst” as used herein, indicates any compound suitable affect and in particular enhance the rate of a reaction. In some embodiments suitable catalyst in arrangement, devices, compositions, methods and systems herein described comprise: platinum based catalysts, iron, manganese, nickel and cobalt based catalysts, soluble and insoluble transition metal oxide catalysts (MOx), soluble and insoluble transition metal chlorides (CoCl2, FeCl3, NiCl2, MnCl2), titanium, zirconium, molybdenum, tungsten and niobium based catalysts. Additional catalysts can be used in accordance with the present disclosure and are identifiable by a skilled person upon reading of the present disclosure.

In particular, in embodiments, where the electron acceptor is a polycyclic aromatic hydrocarbon and in particular polycyclic aromatic hydrocarbon, the arrangements and compositions of the present disclosure can be in the form of solvated electron solutions. The term “solvated electron” refers to an electron which is solvated in a solution. Solvated electrons are not bound to a solvent or solute molecule rather they occupy spaces between the solvent and/or solute molecules. Solutions containing a solvated electron can have a blue or a dark green color or a cupper color at higher concentrations, due to the presence of the solvated electron. Solvated Electron Solutions comprising a solvated electron solution allow for significantly increased hydrogen storage and generation capability (in wt % and in vol. %) when compared with state of the art solid state hydrogen storage and generation systems.

The term “solvated electron solution” or “SES” refers to a solution in which the chemical species involved in hydrogen storage and generation are provided, at least in part, in liquid form. Solvated Electron Solutions systems can contain elements which do not participate in hydrogen storage and generation such as supporting electrolytes, a dissolved catalyst, a supported catalyst, mechanical devices such as a mechanical or a magnetic stirrer, an acoustic or an ultrasonic vibration generator, an electromagnetic wave generator and solvents. A “solvated electron solution” can also contain some insoluble aggregates species. Exemplary SES is described in references [Ref 1] to [Ref 11] each of which is incorporated herein by reference in its entirety.

In embodiments, where the electron acceptor is an organo radical, the arrangements and composition of the present disclosure can be in the form of organometal solutions. The term “organometal solution” refers to a compound consisting of an organic specie such as an alkyl radical and of a strong electron donating metal such as an alkali metal, an alkali-earth metal, boron group metals and metalloids and a solvent. Exemplary suitable compounds comprise organolithiums, organosilanes (e.g. Disilanes, Silanols, Silazanes, Silicates, Siloxanes, Trialkoxysilanes, others identifiable by a skilled person), organoluminums, organogermanium and additional compounds identifiable by a skilled person. N-butyl lithium in hexane is an example of an “organometal solution” for hydrogen storage and generation. Other suitable solvents for N-butyl lithium and/or additional organometal compounds indicated in the present disclosure are identifiable by a skilled person. An “organometal solution” can contain elements which do not participate in hydrogen storage and generation such as supporting electrolytes, a dissolved catalyst, a supported catalyst, mechanical devices such as a mechanical or a magnetic stirrer, an acoustic or an ultrasonic vibration generator, an electromagnetic wave generator and solvents. An “organometal solution” can also contain some insoluble aggregates species.

The terms “aggregate/aggregation” and “coagulate/coagulation” are used equivalently to describe the phenomenon by which a solvated electron solution and an organometal solution form solid precipitate species in the solution. Hydrogen can be stored into and generated from a solvated electron solution and from an organometal solution even when they aggregate or they coagulate.

In an embodiment, SES herein described and organometal solutions can be mixed to form an arrangement comprising one or more SES and one or more organometal solutions.

In several embodiments, SESs and organometal solutions as described herein are capable of effective hydrogen storage, release, and generation, and thereby enable a class of hydrogen storage and generation materials capable of high hydrogen storage and generation capabilities, including at the ambient temperatures and lower pressure. In addition, in an embodiment, the SES and organometal solutions described herein provide hydrogen storage and generation systems combining high storage and generation capacity and enhanced safety with respect to conventional solid state hydrogen storage technology.

In some embodiments, SESs and organometal solutions herein described are highly versatile. They are able to store and generate high amounts of hydrogen at the ambient temperatures and at relatively low hydrogen pressure. Being a gas to liquid reaction the kinetics of hydrogen storage and generation in solvated electron solutions is enhanced with mechanical energy such as solution stirring, ultrasonic vibration, electromagnetic irradiation or all other mechanical and irradiation means known in the art to increase the contact surface between the gas and the liquid phases and to favors hydrogen gas dissolution and transport in the liquid solution. Moreover, the amounts of hydrogen stored in the solvated electron solution increases with increased hydrogen pressure and with lower reaction temperature. Reciprocally, the amounts of hydrogen generated from the solvated electron solution will increase with lower hydrogen gas pressure and with higher reaction temperature.

In various embodiments, hydrogen storage and/or generating arrangements herein described can be provided by contacting the electron donor and the electron acceptor for a time and under conditions to allow at least a portion of the electron donor comprising the electron donor metal to be dissolved in the solvent, thereby generating chemical species capable of reacting with hydrogen to store hydrogen in the solvent.

In some embodiments, the solvent the electron donor and electron acceptor can be mixed under standard temperature and pressure, possibly under an inert atmosphere (e.g. glove box) according to procedure identifiable by a skilled person upon reading of the present disclosure.

In an embodiment, where the arrangement is in form of SES metal:electron acceptor:solvent molar ratio is of about 1-6:0.01-10:1-15. In an embodiment, where the arrangement is in form of MOR the metal:electron acceptor:solvent molar ratio is of about 1-6:0.1-10:1-15.

Exemplary procedures to provide SES suitable in arrangements, methods and systems herein described are illustrated in Examples 1 to 3.

Exemplary procedures to provide organometal solutions suitable in arrangements, methods and systems herein described are illustrated in Example 4.

In some embodiments, arrangements herein described are used in methods and/or systems to store hydrogen. The method comprises contacting hydrogen with a hydrogen storage arrangement comprising an electron donor and an electron acceptor provided in a solvent herein described wherein the arrangement comprises chemical species capable to react with hydrogen. In the method the contacting is performed for a time and under condition to allow reaction of the hydrogen with the chemical species to store hydrogen in the arrangement. The term “contacting” or “to contact” as used herein refers to directly or indirectly causing at least two moieties to come into physical association with each other. Contacting thus includes physical acts such as placing the moieties together in a container.

In some embodiments herein described, wherein the arrangement is in H₂ is expected to dissolve in the SES or organometallic solutions (MOR) during storage and is released during de-storage according to the following compositional equations:

Mₙ(PAH)ₘ(Solv.)_{q}+pH₂→Mₙ(PAH)ₘ(Solv.)_{q}H₂ₚ <eq 1> storage and,

Mₙ(OR)ₘ+pH₂→Mₙ(OR)ₘH₂ₚ <eq. 1′> storage

wherein M is the electron donor metal (e.g. Li), PAH (e.g. Naphtalene), OR is an organoradicl (e.g. butyl), Solv. is a solvent and in particular an organic solvent (e.g. tetrahydrofuran), and Mₙ(PAH)ₘ(Solv.)_{q}H₂ₚ and Mₙ(OR)ₘH₂ₚ are a metal hydride organic complex, and wherein in <eq. 1> m, n and q are as follows about 0.1<n<about 15, about 0.075<m<about 7.5, about 1<q<about 50 and about 0.05n<p<10n, and wherein in <eq. 1′> m and n have are as follows about 1<n<6, about 0.1<m<about 10, and about 0.05n<p<10n.

The term “metal hydride complex” as used herein indicates a complex including a M—H bond that is weaker than in metal hydrides. A “metal hydride organic complex” as used herein indicates a metal hydride complex further comprising an organic moiety (e.g. PAH or OR). A possible explanation for the weaker bond between M and H that characterizes metal hydride complexes that is not intended to be limiting and is herein included for guidance purpose only, is that the M—H bond is weakened by the solvent and/or the solvated electron in the solvent.

Accordingly, in some embodiments, hydrogen stored in the SES or MOR is easier to recover than in metal hydride, which typically but not necessarily requires heating at higher temperatures. In some embodiments, hydrogen in the SES or MOR can be recovered at the ambient temperatures and/or at lower temperature compared to conventional metal hydrides.

In an embodiment, M can be one or more of an alkali metal, an alkali earth metal and/or a lanthanide metal. In an embodiment M can be one or more of aluminum, zinc, carbon, silicon, germanium, lanthanum, europium, strontium or an alloy of these metals. In some embodiments the electron donor metal may be provided as a metal hydride, a metal aluminohydride, a metal borohydride, a metal aluminoborohydride or metal polymer. Metal hydrides are known in the art, for example in A. Hajos, “Complex Hydrides”, Elservier, Amsterdam, 1979 which is incorporated by reference herein in its entirety to the extent not inconsistent with the present description. In an embodiment, M can be Li and/or K.

In some embodiments, the concentration of the electron donor metal ions in the solvent is greater than or equal to about 0.1 M, optionally for some applications greater than or equal to 0.2 M and optionally for some applications greater than or equal to about 1 M. In particular in some embodiments wherein the arrangement or composition is in the form of a SES solution, it is possible to use excess of metal in the SES solution. In some of those embodiments the excess metal will serve as “reservoir” for solvated electrons once the SES combines with hydrogen, hence increasing the amounts of hydrogen stored. Accordingly in some embodiment metal M can be added to the SES in a solid state form (e.g. in the form of chunk, foil and powder). The SES then can be saturated with the metal and with solvated electrons. When hydrogen is added, metal hydride complex forms. The added metal in excess dissolves in the SES generating more solvated electrons thus allowing more hydrogen to be stored in the form of metal hydride complex. In some of those embodiments, the amounts of added M should be in the range of 0.1 to 50 moles/liter of solvent, and in particular 1 to 50 moles, more particularly 5 to 50 moles.

In some embodiments, the concentration of the electron donor metal ions in the solvent is selected over the range of about 0.1 M to 10 M, optionally for some applications selected over the range of about 0.2 M to about 5 M and optionally for some applications selected over the range of about 0.2 M to about 2 M.

A range of suitable polycyclic aromatic hydrocarbons (PAH) include one or more of Azulene, Naphthalene, 1-Methylnaphthalene, Acenaphthene, Acenaphthylene, Anthracene, Fluorene, Phenalene, Phenanthrene, Benzo[a]anthracene, Benzo[a]phenanthrene, Chrysene, Fluoranthene, Pyrene, Tetracene, Triphenylene Anthanthrene, Benzopyrene, Benzo[a]pyrene, Benzo[e]fluoranthene, Benzo[ghi]perylene, Benzo[j]fluoranthene, Benzo[k]fluoranthene, Corannulene, Coronene, Dicoronylene, Helicene, Heptacene, Hexacene, Ovalene, Pentacene, Picene, Perylene, Tetraphenylene, and mixtures of these PAH. In some of those embodiments, the PAH is substituted according to the stoichiometry of formula (I).

In an embodiment organometallic solution comprises an alkyl radical and of a strong electron donating metal such as an alkali metal (i.e. alkyl-alkali metal), an alkali-earth metal (i.e. alkyl-alkali-earth metal), boron and aluminum and a solvent. N-butyl lithium in hexane is an example of an “organometallic solution” for hydrogen storage and generation.

The term “alkyl-alkali metal” refers to a combination of an alkyl organic radical with an alkali metal atom or atoms, where the alkyl radical indicates a series of branched or unbranched univalent groups of the general formula CzH2z+1 derived from aliphatic hydrocarbons wherein 1≦z. Exemplary alkyl-alkali metal comprise methyllithium, methylsodium, methylpotassium, methylrubidium, methylcaesium, methylfrancium, ethyllithium, ethylsodium, ethylpotassium, etheylrubidium, ethylcaesium, ethylfrancium, propyllithium, propylsodium, propylpotassium, propylrubidum, proplycaesium propylfrancium, butyllithium, butylsodium, butylpotassium, butylrubidium, butylcaesium, butylfrancium, pentyllithium, pentylsodium, pentylpotassium, pentylrubidum, pentylcasesium, pentylfrancium, hexyllithium, hexylsodium, hexylpotassium, hexylrubidium, hexylcaesium, hexylfrancium, heptyllithium, heptylsodium, heptylpotassium, heptylrubidium, heptylcaesium, heptylfrancium, octyllithium, octylsodium, octylpotassium, octylrubidium, octylcaesium, octylfrancium, nonyllithium, nonylsodium, nonylpotassium, nonylrubidium, nonylcaesium, nonylfrancium, decyllithium, decylsodium, decylpotassium, decylrubidium, decylcaesium, decylfrancium, undecyllithium, undecylsodium, undecylpotassium, undecylrubidium, undecylcaesium, undecylfrancium, dodecyllithium, dodecylsodium, dodecylpotassium, dodecylrubidium, dodecylcaesium, and dodecylfrancium.

In some embodiments, the concentration of the electron acceptor in the solvent is greater than or equal to about 0.1 M, optionally for some applications greater than or equal to 0.2 M and optionally for some applications greater than or equal to 1 M. In some embodiments, the concentration of the electron acceptor in the solvent is selected over the range of 0.1 M to 15 M, optionally for some applications selected over the range of 0.2 M to 5 M and optionally for some applications selected over the range of 0.2 M to 2 M.

A range of solvents can be used with the SESs and hydrogen storage and generation systems described herein. Solvents capable of dissolving significant amounts of (e.g., generating about 0.1-15 M solutions of) electron donor metals and electron acceptors are preferred for some applications.

In some embodiments, for example, the solvent is water, tetrahydrofuran (THF), hexane, pentane, heptane, ethylene carbonate, propylene carbonate, benzene, carbon disulfide, carbon tetrachloride, diethyl ether, ethanol, chloroform, ether, dimethyl ether, benzene, propanol, acetic acid, alcohols, isobutylacetate, n-butyric acid, ethyl acetate, N-methylpyrrolidone, N,N-dimethylformiate, ethylamine, isopropyl amine, hexamethylphosphotriamide, dimethyl sulfoxide, tetralkylurea, triphenylphosphine oxide or mixture thereof. In some embodiments, a mixture of solvents will be desirable such that one solvent of the mixture can solvate an electron acceptor while another solvent of the mixture can solvate a supporting electrolyte. In an embodiment, the solvent can be THF, benzene and/or naphthalene or a mixture thereof. In an embodiments, the Naphthalene, Anthracene, and Pyrene or a mixture thereof. In an embodiment where the electron donor metal comprises an alkali metal the solvent can be THF, naphthalene and tetracene can be used to dissolve the alkali metal or a mixture thereof.

In some embodiments, suitable solvents for SES and MOR solutions comprise Tetrahydrofuran (THF), furan, pyrrolidine, dioxane, diethyl ether, pyrrole, pyrroline, pyrrolizine, thiophene, thioethers, tetrahydrothiophene, diethylsulfide, benzothiophene, dibenzothiophene, dimethylformamide (DMF), dimethyl sulfoxide, acetonitrile, n-methylformamide, acetamide, formamide, hexamethylphosphoramide (HMPA), hexamethylphosphorous triamide (HMPT), n-Methylpyrrolidone (NMP), isobutyl acetate, ethyl acetate, benzene, hexane, carbon tetrachloride, dioxymethane, cyclohexane, pentane, heptanes, toluene and acetone.

In some embodiments suitable solvent comprise one or more inorganic solvent. Exemplary suitable inorganic solvents comprise tetraborohydide BH₄, tetraaluminohydide AlH₄, silico-alumino hydrides (e.g. Si_{y}Al_{1-y}H₄, boro-silico hydrides Si_{y}B_{1-y}H₄, and/or boro-alumino hydrides B_{y}Al_{1-y}H₄ wherein 0<y<1). Additional inorganic suitable insolvents are identifiable by a skilled person upon reading of the present disclosure.

In an embodiment, an amount of Mₙ(PAH)ₘ and in particular the PAH, dissolved in the solvent so that the amount is large but such that that the solution coagulates. For example the optimal molar concentration Metal:PAH:Solvent in embodiments where coagulation is not desired has been determined to be about 1-6:1-3:2-12.33, preferably to be about 1-4:1-2:4-12.33 and more preferably to be about 1-2:1-2:6-12.33, for the exemplary SES comprising Li/Naphthalene/THF. One skilled in the art would recognize that any concentration allowing the metal and PAH to be dissolved in an SES would allow hydrogen storage.

In an embodiment, an amount of dissolved Mₙ(OR)ₘ in the solvent so that the amount is large but such that that the solution coagulates. For example the optimal molar concentration Metal:OR:Solvent in embodiments where coagulation is not desired has been determined to be about 1-3:1-3:2-8, preferably to be about 1-2:1-2:4-8 and more preferably to be about 1-2:1-2:6-8 for the exemplary MOR comprising Li/Butyl/Hexane. One skilled in the art would recognize that any concentration allowing the metal and organic radical to be dissolved in a MOR would allow hydrogen storage.

In some embodiments, typical solvents for MOR are: dibutyl ether, dioxymethane, diethyl ether, benzene, cyclohexane, pentane, THF, heptanes, hexane and toluene.

In an embodiment hydrogen can be introduced and stored in the arrangement directly via a single step wherein the hydrogen is contacted with the arrangement for a time and under condition to allow hydrogen storage in the arrangement. The time, temperature and pressure depend on the specific arrangement used and will be identifiable by a skilled person upon reading of the present disclosure.

In some of those embodiments, hydrogen introduction can be performed at moderate pressures, for example, around 10 atm, although hydrogen can be stored at lower and higher pressures. In some embodiments, hydrogen pressure is in the range of about 1-200 atm. In some of those embodiments, the hydrogen pressure is in the range of about 5-100 atm. In some of those embodiments, the hydrogen pressure is in the range of about 10-50 atm.

In some embodiments hydrogen storage can be performed at room temperature, although hydrogen storage can be performed at higher or lower temperatures. In particular, in some embodiments hydrogen storage can be performed at a temperature that is substantially comprised between the melting temperature and the boiling temperature of the solvent. For example, in an embodiment where the solvent is THF (typically but not exclusively with SES), hydrogen storage can be performed at a temperature of from about −108.4 C to about +66 C. In an embodiment where the solvent is exane (typically but not exclusively with MOR), hydrogen storage can be performed at a temperature from about −95 C, to about +69 C. Additional suitable temperatures are identifiable by a skilled person and correspond for example to temperatures comprised between melting and boiling points of various solvents or mixture thereof or other suitable temperature identifiable by a skilled person.

In an embodiment, methods to introduce hydrogen the contacting can be performed in a single step. In some of those embodiments the pressure and/or temperature are maintained substantially constant during the contacting.

In an embodiment, hydrogen can be introduced in the multistep process. In some of those embodiments, the hydrogen is contacted at a first pressure, and the contacting is performed for a time and under condition allowing the hydrogen pressure to stabilize as the hydrogen is stored at a second pressure typically substantially lower then the first pressure. An additional amount of hydrogen is then added at a third pressure which is typically equal or higher than the second pressure with a contacting performed for a time and under condition to allow the hydrogen pressure to stabilize at a fourth pressure which is typically substantially equal or lower than the third pressure. The process can be repeated for a number of times depending on the desired hydrogen storage and on the specific arrangement used, as will be understood by a skilled person.

The term “substantially” as used herein with reference to a quality of a parameter indicates a value of the parameter that is the one specified plus or minus variations of the value that not significantly affect the specified quality. A skilled person will be able to identify these variations based on the specific parameter and quality indicated.

In some embodiments, arrangements, methods and systems are described where hydrogen storage in SES occurs without a metal (Example 5). In some embodiments, arrangements, methods and systems are provided where hydrogen storage in SES occur using potassium as a metal (Example 6). In some embodiments, arrangements, methods and systems are provided where hydrogen storage in SES occur using lithium as a metal (Example 7).

In some embodiments, hydrogen can be released from a hydrogen storage arrangement by providing a hydrogen storage arrangement comprising hydrogen herein described, typically within a metal hydride complex, the hydrogen storage arrangement provided at an arrangement pressure and decreasing the arrangement pressure to release hydrogen.

In arrangements in form of SES and/or MOR the arrangement typically comprises hydrogen within a metal hydride organic complex herein described. In some of those embodiments, reverse compositional equations, directed to release of the hydrogen from the metal hydride organic complex are expected to take place during H2 de-storage in both equation 1 and 1′.

In an embodiment, hydrogen can be released in a single step process wherein the arrangement pressure is decreased for example from an initial arrangement pressure to a final arrangement pressure substantially lower than the initial pressure and associated to hydrogen release from the arrangement. In an embodiment, hydrogen can be released with a multi-steps process wherein an initial arrangement pressure is decreased to a final arrangement pressure substantially lower than the initial arrangement pressure through a plurality of intermediate arrangement pressures. In particular, in some of these embodiments, the initial arrangement pressure is first decreased to a first intermediate arrangement pressure which is substantially lower than the initial arrangement pressure. The first intermediate arrangement pressure is then decreased to a second intermediate arrangement pressure which is substantially lower than the first intermediate arrangement pressure. The second intermediate arrangement pressure can then be lowered to the final arrangement pressure through an additional number of intermediate arrangement pressures that can be identified by a skilled person based on the specific arrangement and desired hydrogen release.

Exemplary procedures to release hydrogen from a metal hydride organic complex in an SES or MOR are illustrated in the Examples (see Examples 8-9 and 11). Additional procedures suitable to release hydrogen from arrangement comprising stored hydrogen include agitation and additional approaches identifiable by a skilled person upon reading of the present disclosure.

In an embodiment, hydrogen release can be performed at room temperature and pressure according to single step or multi-step procedures wherein at each step the temperature is maintained substantially constant, and the pressure is decreased at a constant rate. Additional temperatures and pressures as well as temperature and pressure variations are identifiable by a skilled person in view of the specific arrangement and desired release. In particular in some embodiments, a suitable combination of temperature and pressure is selected to minimize solvent vaporization.

In some embodiments, suitable temperatures for hydrogen release are in the range of the melting point and the boiling point of the solvent. In embodiment where the solvent is THF, which have melting point and boiling point temperatures of −108.4 C (melting point) or 66 C (boiling point) respectively suitable temperature are expected to be below −108.4 C and above 66 C. For example, in THF based SESs, the suitable temperature ranges are expected to be from about −50 C to about +50 C and more particularly from about −30 C to about +40 C. Additional suitable temperatures for arrangement comprising different solvents are identifiable to a skilled person. In embodiment where the solvent is hexane, which have melting point and boiling point temperatures of −95 C (melting point) or 69 C (boiling point) respectively, suitable temperatures are expected to be below −95 C and above 69 C. For example, in hexane based MOR, the suitable temperature ranges are expected to be from about −50 C to about +50 C and more particularly from about −20 C to about +50 C. Additional suitable temperatures for arrangement comprising different solvents are identifiable by a skilled person.

Exemplary procedures for hydrogen storage and release in SES or MOR are described in Examples 8, 9 and 11.

In some embodiments, wherein hydrogen is released separation of hydrogen from evaporated solvent can be performed upon release or thereafter using an appropriate filter suitable to select the hydrogen from a mixture further comprising other molecules and in particular the specific solvent or mixture thereof used in the arrangement. In some exemplary embodiments, a ceramic membrane that is selectively permeable to hydrogen can be used to allow physical separation between hydrogen and solvent molecules (see Examples 8 and 9).

In some embodiments, hydrogen can be stored and released in a suitable solvent herein described. In those embodiments hydrogen storage can be performed by contacting hydrogen with a solvent for a time and under condition to allow reaction of the hydrogen with the solvent. Any of the solvents herein described can be used to store hydrogen according to methods herein described. An exemplary embodiment wherein hydrogen is stored in a solvent in absence of electron donor and electron acceptor is illustrated in Example 5. In some of those embodiments hydrogen can be released from a solution obtainable with a method to store hydrogen herein described. In particular, release from those solutions can be performed in some embodiments by providing a solutions comprising hydrogen herein described at a starting pressure and decreasing the starting pressure to release hydrogen.

In some embodiments, arrangements, methods and systems can be provided that are suitable to generate hydrogen. The hydrogen generating arrangement comprises an electron donor and an electron acceptor herein described provided in a solvent herein described. In the hydrogen generating arrangement the electron donor metal and the electron acceptor are capable to react with water or another molecule, in particular an organic molecule, which comprises a labile proton, to generate hydrogen

In an embodiment, SES or MOR can be used to generate hydrogen in methods and systems herein described. The method comprises contacting water or an organic molecule comprising a labile proton with a Solvated Electron Solution comprising an alkali metal and/or an alkali earth metal in an organic aromatic solvent, the contacting performed for a time and under condition to generate hydrogen metal hydroxide and metal oxide.

In some embodiments, methods are provided in which hydrogen storage and generation, or release from H₂O, alcohol, or other molecules with labile proton. Without being bound by any theory, in particular in some embodiments, hydrogen is expected to be released from SES and MOR solutions by reaction with water and alcohol for example, according to the following compositional equations:

Mₙ(PAH)ₘ(Solv.)_{q}+n(s+t)H₂O→nMOₛ(OH)ₜ+nsH₂+mPAH+qSolv. <eq. 2>

Mₙ(OR)ₘ+n(s+t)H₂O→nMOₛ(OH)ₜ+nsH₂+m/2(OR)₂ <eq. 2′> and,

Mₙ(PAH)ₘ(Solv.)_{q}+nR—OH→nR—O—Li+n/2H₂+mPAH+qSolv. <eq. 3>

Mₙ(OR)ₘ+nR′—OH→nR′—O—Li+n/2H₂+m/2(OR)₂ <eq. 3′>

wherein M, PAH, Sol OR, n, m and q can have any of the value indicated above for equation <eq. 1> and <eq. 1′> wherein in <eq. 2> and <eq. 3> m, n and q are as follows about 0.1<n<about 15, about 0.075<m<about 7.5, about 1<q<about 50 and about 0.05n<p<10n, 0<s<about 2, 0≦t≦4 and wherein in <eq. 2′> and <eq. 3′> m and n have are as follows about 1<n<6, about 0.1<m<about 10, and about 0.05n<p<10n, 0≦s≦about 2, 0≦t≦4

In equations <eq. 2> and <eq 2′>, MOₛ(OH)ₜ indicates the oxidation product of the metal, which in some embodiments, can be an oxide, a hydroxide or an oxide-hydroxide or a mixture thereof.

In some embodiments, methods are provided in which hydrogen generation, or release from H₂O, alcohol, or other organic molecules with labile proton is performed with arrangement and compositions in form of SES. In some of these embodiments, without being bound by any theory, the hydrogen generation can follow the compositional equations herein indicated with the exemplary H20 and alcohol:

Mₙ(PAH)ₘ(Solv.)_{q}+n(s+t)H₂O→nMOₛ(OH)ₖ+mPAH+qSolv.+n(s+t/2)H₂ <eq. 4>

Mₙ(PAH)ₘ(Solv.)_{q}+nROH→nROM+mPAH+qSolv.+n/2H₂ <eq. 4′>

wherein in <eq. 4> and <eq. 4′> m, n and q are as follows about 0.1<n<about 15, about 0.075<m<about 7.5, about 1<q<about 50 and about 0.05n<p<10n, 0≦s≦about 2, 0≦t≦4; and wherein MOₛ(OH)ₖ is a general representation of the metal oxidation product which in some embodiments can be an oxide (k=0), a hydroxide (s=0), a metal oxide-hydroxide (k>0 and s>0) or a combination thereof and

In embodiments, wherein arrangements and compositions herein described are in the form of MOR, without being bound by any theory, hydrogen generation can be performed according to the following compositional equations:

Mₙ(OR)ₘ+n(s+t)H₂O→nMOₛ(OH)ₖ+n(s+t/2)H₂+m/2(OR)₂ <eq. 5>

Mₙ(OR)ₘ+nR′OH→nR′OM+n/2H₂+m/2(OR)₂ <eq. 5′>

wherein in <eq. 5> and <eq. 5′> m and n have are as follows about 1<n<6, about 0.1<m<about 10, and about 0.05n<p<10n, 0≦s≦about 2, 0≦t≦4 and the contacting is performed in THF or other suitable solvent herein described.

In some embodiments, other compounds having a labile proton can be used in place or in addition to water or alcohol alone or in suitable mixtures. A non-exhaustive list of organic compounds or functional groups with labile hydrogen (proton) comprises alcohols, aldehydes, carboxylic acids, hydroperoxides, amides, amines, imines, sulfonic acids, thiols, phosphines, phosphonic acids and phosphates. Typically, all organic and inorganic compounds having one or a combination of these functional groups are good reactants for hydrogen production when in put in contact with SESs and MORs. A non exhaustive list of inorganic reactant liquids with labile hydrogen (proton) comprises water, hydrogen peroxide (H₂O₂), inorganic acid solutions in water, inorganic base solutions in water. Additional suitable organic and inorganic compounds are identifiable by a skilled person.

In some embodiments, the contacting to generate hydrogen is performed between a SES/MOR and a combination of organic and inorganic reactants having a labile proton is used in connection with arrangements and compositions herein described. In an embodiment, the contacting can be performed, for example, by the addition of water to a Ga covered Al metal. Water added to NaBH₄ further allows the release of bound hydrogen in the borohydride.

Metal oxide and/or metal hydroxide and/or metal oxide-hydroxide compounds can be formed as result of water or alcohol reaction with SES and/or MOR, which generates hydrogen.

Exemplary descriptions of hydrogen storage and generation from H₂O, alcohol, or other organic molecules are described in (Example 10) and (Example 11).

In some embodiments, SES/MOR on one side and one or more compounds having a labile proton on the other side can be stored in two different compartments of a device (e.g. tanks or other suitable containers) and be mixed under controlled atmosphere and controlled fluxes to produce hydrogen. Contacting between SES/MOR and a compound having a labile proton can be achieved in different ways identifiable by a skilled person.

For example, in some embodiments, H₂O or other compound having labile proton can be introduced in the SES/MOR container at controlled rate (see Example 10). In some of those embodiments, hydrogen can be immediately generated according to eq. 4 and 4′ and 5 and 5′. In particular, the rate H₂ generation is usually proportional to the rate of compound having labile proton (e.g. water or alcohol) that is introduced. In some of those embodiments, the reaction typically generates heat.

In further exemplary embodiments, SES/MOR and compound having a labile proton are jointly introduced in a third container and H₂ is produced in the third contained. The rate of H₂ production is typically proportional to the rate of SES/MOR and compound having a labile proton's introduction, the compositional ratio of which can be determined according to eq. 4, 4′ and 5, 5′.

In additional exemplary embodiments, SES/MOR and compound having a labile proton are co-sprayed in a same container at pressure that is higher to the pressure of the container. In some of those embodiments, the approach is performed similarly to gas and air injection in an internal combustion car engine. In those embodiments, high pressure typically favors an efficient contact between reactants in the quasi vapor phase in a spray.

In some embodiments, wherein hydrogen is released separation of hydrogen from evaporated solvent can be performed upon release or thereafter using an appropriate filter suitable to select the hydrogen from a mixture further comprising other molecules and in particular the specific solvent or mixture thereof used in the arrangement. In some exemplary embodiments, a ceramic membrane that is selectively permeable to hydrogen can be used to allow physical separation between hydrogen and solvent molecules.

In some embodiments, wherein hydrogen is generated separation of hydrogen from evaporated solvent can be performed upon release or thereafter using an appropriate filter suitable to select the hydrogen from a mixture further comprising other molecules and in particular the specific solvent or mixture thereof used in the arrangement. In some exemplary embodiments, a ceramic membrane that is selectively permeable to hydrogen can be used to allow physical separation between hydrogen and solvent molecules (Examples 10 and 11).

In an embodiment, an arrangement to store or generate hydrogen can comprise an electron donor comprising an electron donor metal, wherein the electron donor metal is an alkali metal, an alkali earth metal, a lanthanide metal or alloy thereof; an electron acceptor provided in a solvent, wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent or an organometal in the solvent, respectively.

In an embodiment, an arrangement to store or generate hydrogen can comprise an electron donor comprising an electron donor metal provided in a solvent, wherein the electron donor metal is lithium; an electron acceptor provided in the solvent, wherein the electron acceptor is a polycyclic aromatic hydrocarbon; wherein at least a portion of the electron donor comprising an electron donor metal is dissolved in the solvent, thereby generating metal ions and solvated electrons in the solvent.

In an embodiment, an arrangement to store or generate hydrogen can comprise an electron donor comprising an electron donor metal provided in a solvent, wherein the electron donor metal is sodium; an electron acceptor provided in the solvent, wherein the electron acceptor is a polycyclic aromatic hydrocarbon, thereby generating sodium ions and solvated electrons in the solvent.

In an embodiment, an arrangement to store or generate hydrogen can comprise an electron donor comprising an electron donor metal provided in a solvent, wherein the electron donor metal is potassium; an electron acceptor provided in the solvent, wherein the electron acceptor is a polycyclic aromatic hydrocarbon, thereby generating potassium ions and solvated electrons in the solvent.

In an embodiment, an arrangement to store or generate hydrogen can comprise an electron donor metal provided in a solvent, wherein the electron donor metal is an alkali metal, an alkali earth metal, a lanthanide metal or alloy thereof; an electron acceptor provided in the solvent, wherein the electron acceptor is a polycyclic aromatic hydrocarbon or an organo radical; a supporting electrolyte comprising a metal at least partially dissolved in the solvent, thereby generating electron donor metal ions and solvated electrons in the solvent.

In some embodiments, SES and MOR and mixture thereof herein described tend to aggregate with time to form a solid state phase within the solution. Such an aggregation does not affect the solvated electron solutions and the organometal solutions capacity to store and generate hydrogen according to this disclosure. Aggregates are highly concentrated solvated electron solutions and organometal solutions as they contain large amounts of the liquid solvent. A high concentration of solvated electron solutions and organometal solutions and aggregates is desirable in order to increase the weight and the volume percent of stored and generated hydrogen in the solution and in the aggregate.

In some embodiments, a solvated electron solution can be used in a hydrogen storage and generation system, the solvated electron solution comprising: an electron donor comprising an electron donor metal provided in a solvent, wherein the electron donor metal is an alkali metal, an alkali earth metal, a lanthanide metal or alloy thereof; an electron acceptor provided in the solvent, wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent. In an embodiment, the solvated electron solution further comprises a source of the electron donor metal, the electron acceptor or the solvent operationally connected to the solvated electron solution.

In some embodiments, hydrogen arrangements, compositions, methods and systems herein described comprise an organo radical as an electron acceptor and are in form of organometallic solutions with alkali metal and alkali earth metals such as butyl lithium (BuLi) solution in hexane, the butyl sodium (BuNa) in hexane and dibutylmagnesium in hexane and diethylmagnesium in hexane.

In some embodiments, organo radicals in arrangement and compositions herein described for hydrogen storage and generation react via a charge transfer, partial electron transfer, or full electron transfer reaction with the electron donor metal to form an organometallic reagent. Useful organo radicals include, for example, alkyl radicals (such as butyl radical, phenyl radical, biphenyl radical or acetyl radical), allyl radicals, amino radicals, imido radicals and phosphino radicals.

As disclosed herein, the electron donor, electron acceptor and solvent herein described can be provided as a part of systems to store, release and/or generate hydrogen, including any of the methods described herein. The systems can be provided in the form of kits of parts.

In a kit of parts, the electron donor, electron acceptor and solvent and other reagents to perform the methods can be comprised in the kit independently. One or more electron donor, electron acceptor and solvent can be included in one or more compositions alone or in mixtures identifiable by a skilled person. Each of the one or more electron donors, electron acceptors and solvents can be in a composition together with a suitable vehicle.

Additional reagents can include molecules suitable to enhance or favor the contacting according to any embodiments herein described and/or molecules, standards and/or equipment to allow detection of pressure temperature and possibly other suitable conditions.

In particular, the components of the kit can be provided, with suitable instructions and other necessary reagents, in order to perform the methods here described. The kit will normally contain the compositions in separate containers. Instructions, for example written or audio instructions, on paper or electronic support such as tapes or CD-ROMs, for carrying out the assay, will usually be included in the kit. The kit can also contain, depending on the particular method used, other packaged reagents and materials (e.g. wash buffers and the like).

In some embodiments, the electron donor, electron acceptor and solvent herein described can be included in compositions together with suitable an excipient or diluent identifiable by a skilled person.

The arrangement, compositions, methods and systems herein described can be used for several application including hydrogen storage, research in storing gases such as hydrogen, CO2, methane in aromatic compounds. In several embodiments, arrangements, compositions methods and systems herein described are expected to allow for higher hydrogen gas uptake in these hydrogen storage materials. In a hydrogen car, for example, a large amount of hydrogen needs to be safely stored to power the car, and better hydrogen storage materials will allow the car to drive longer. In addition, CO₂ gas could be collected from the atmosphere and stored in the framework to reduce the greenhouse effect.

Other industrial processes arrangement, compositions, methods and systems herein described are expected to be useful include processes that deal with Chlorine (e.g. the production of PVC) which produces waste hydrogen, in many instances at ˜99% purity. This waste hydrogen is typically flared off due to the expense of storage by compression, and can be stored instead as described herein

Further advantages and characteristics of the present disclosure will become more apparent hereinafter from the following detailed disclosure by way of illustration only with reference to an experimental section.

### EXAMPLES

The compositions, methods system herein described are further illustrated in the following examples, which are provided by way of illustration and are not intended to be limiting.

In particular, the following examples illustrate exemplary SESs and related methods and systems. A person skilled in the art will appreciate the applicability and the necessary modifications to adapt the features described in detail in the present section, to additional solutions, methods and systems according to embodiments of the present disclosure.

### Example 1

### Solvated Electron Solution

Alkali metals (AM) and other electron donor metal ions form solvated electron (SE) solutions with a variety of molecules, including polycyclic aromatic hydrocarbons (PAHs) such as naphthalene. Many polycyclic aromatic hydrocarbons are solid at room temperature and, therefore, can be provided dissolved in a suitable solvent. Solvated electron complexes can be formed by dissolving the electron donor metal in a polycyclic aromatic hydrocarbon solution such as naphthalene in tetrahydrofuran. The solution takes a green-blue color characteristic of solvated electron complexes.

Alkali metals (AM) and other electron donor metal ions form organometal solutions with a variety of solvents, including hydrocarbons such as hexane, benzene, cyclohexane and diethyl ether.

### Example 2

### Realization of a Solvated Electron Solution

It is known that lithium can be dissolved in solutions containing polycyclic aromatic hydrocarbons such as naphthalene or biphenyl due to the high electron affinity of the polycyclic aromatic hydrocarbons. The reaction forming solvated electrons for both biphenyl and naphthalene are shown in compositional equations <eq. 6> and <eq. 7>, below. Such lithium solutions, however, are not used in commercial hydrogen storage and generation applications because of their extreme reactive character in particular with air and with water.

2Li₍ₘₑₜₐₗ₎+biphenyl→[2Li⁺,(2e⁻,biphenyl)]< eq. 6>

2Li₍ₘₑₜₐₗ₎+naphthalene→[2Li⁺,(2e⁻,naphthalene)]< eq. 7>.

Four lithium-naphtalene based solvated electron solutions were prepared in THF solvent and are labeled 1 to 4 in Table 1.

TABLE 1
Different solvated electron solutions prepared with lithium and naphthalene in THF solvent.

| | Li | Li(mols) | Naphththalene | Naphththalene | THF | THF | Result(dissolved, |
|---|---|---|---|---|---|---|---|
| | (grams) | Li/Naph | (grams) | (mols) | (grams) | (mols) | undisolved, coagulate) |
| 1 | 0.135 | .0194 | 1.28 | .010 | 8.8 | .122 | Dissolved then |
| | | 1.94 | | THF/Naph = 12.2 | | | coagulated |
| 2 | .597 | .086 | 5.5 | .0429 | 8.8 | .122 | Dissolved then |
| | | 2 | | THF/Naph = 2.8 | | | coagulated |
| 3 | .459 | .0661 | 8.4 | .0655 | 8.8 | .122 | Dissolved |
| | | 0.99 | | THF/Naph = 1.86 | | | |
| 4 | .270 | .0389 | 1.28 | .010 | 8.8 | .122 | Undisolved |
| | | 3.89 | | THF/Naph = 12.2 | | | |

Max amount of lithium per NAH: 2 to 1 (sample 1 and 2)
Max amount of lithium dissolved per THF: 2 to 3 (sample 2)
Max NAH dissolved in THF: 1 to 2 (sample 3)

The mass and the mole amounts together with the molar ratio of Li, naphthalene and THF in each solution are given in the Table. Three Li/Naphtalene molar ratio were targeted: 1, 2 and 4. The terms “coagulated” and “undissolved” in the Table refer to the solutions where a solid phase was observed due to solution coagulation or to incomplete dissolution of lithium in the solvated electron solution, respectively.

Crown ethers are a class of cation receptors exhibiting chemical and physical properties beneficial for enhancing the dissolution of inorganic fluorides, including LiF. These compounds are useful for complexing with metal ions in solution. Crown ether cation receptors useful in the present disclosure include, but are not limited to, Benzo-15-crown-5,15-Crown-5,18-Crown-6, Cyclohexyl-15-crown-5, Dibenzo-18-crown-6, Dicyclohexyl-18-crown-6, Di-t-butyldibenzo-18-crown-6, 4,4i⁻(5i⁻)-Di-tert-butyldibenzo-24-crown-8, 4-Aminobenzo-15-Crown-5, Benzo-15-Crown-5, Benzo-18-crown-6,4-tert-Butylbenzo-15-crown-5, 4-tert-Butylcyclohexano-15-crown-5, 18-Crown-6, Cyclohexano-15-crown-5, Di-2,3-naphtho-30-crown-10, 4,4′(5′)-Di-tertbutyldibenzo18-crown-6,4′-(5′)-Di-tert-butyldicyclohexano-18-crown-6, 4,4′(5′)-Di-tertbutyldicyclohexano-24-crown-8, 4,10-Diaza-15-crown-5, Dibenzo-18-crown-6, Dibenzo-21-crown-7, Dibenzo-24-crown-8, Dibenzo-30-crown-10, Dicyclohexano-18-crown-6, Dicyclohexano-21-crown-7,Dicyclohexano-24-crown-8, 2,6-Diketo-18-crown-6, 2,3-Naphtho-15-crown-5,4′-Nitrobenzo-15-crown-5, Tetraaza-12-crown-4 tetrahydrochloride, Tetraaza-12-crown-4 tetrahydrogen sulfate, 1,4,10,13-Tetraoxa-7,16-diazacyclooctadecane, 12-crown-4,15-crown-5, and 21-crown-7.

### (iv) Ionic Liquids

Ionic liquids useful for metal oxide dissolution include, but are not limited to, the following:

Acetates: 1-Butyl-3-methylimidazolium trifluoroacetate, 1-Butyl-1-methylpyrrolidinium trifluoroacetate, 1-Ethyl-3-methylimidazolium trifluoroacetate, and Methyltrioctylammonium trifluoroacetate.

Amides and Imides: 1-Butyl-2,3-dimethylimidazolium bis(trifluoromethylsulfonyl)imide, 1-Butyl-3-methylimidazolium bis(trifluoromethylsulfonyl)imide, 490015 1-Butyl-3-methylimidazolium dicyanamide, 1-Butyl-1-methylpyrrolidinium bis(trifluoromethylsulfonyl)imide, 1-Butyl-1-methylpyrrolidinium bis(trifluoromethylsulfonyl)imide, 1-Butyl-1-methylpyrrolidinium bis(trifluoromethylsulfonyl)imide, 1-Butyl-1-methylpyrrolidinium dicyanamide, 2,3-Dimethyl-1-propylimidazolium bis(trifluoromethylsulfonyl)imide, 1-(2-Ethoxyethyl)-1-methylpyrrolidinium bis(trifluoromethylsulfonyl)imide, and N-Ethoxymethyl-N-methylmorpholinium bis(trifluoromethylsulfonyl)imide.

Borates: 1-Butyl-2,3-dimethylimidazolium tetrafluoroborate, 1-Butyl-3-methylimidazolium tetrafluoroborate, 1-Butyl-3-methylimidazolium tetrafluoroborate, N-Butyl-3-methylpyridinium tetrafluoroborate, N-Butyl-4-methylpyridinium tetrafluoroborate, 1-Butyl-1-methylpyrrolidinium bis[oxalato(2-)]borate, 490051 N-Butylpyridinium tetrafluoroborate, 1-Ethyl-3-methylimidazolium bis[oxalato(2-)—O,O⁺]borate, 1-Ethyl-3-methylimidazolium tetrafluoroborate, and 1-Hexyl-3-methylimidazolium tetrafluoroborate.

Cyanates: 1-Butyl-3-methylimidazolium dicyanamide, N-Butyl-3-methylpyridinium dicyanamide, 1-Butyl-1-methylpyrrolidinium dicyanamide, and 1-Ethyl-3-methylimidazolium thiocyanate.

Halogenides: 1-Benzyl-3-methylimidazolium chloride, 1-Butyl-1-methylpyrrolidinium bromide, N-Butyl-3-methylpyridinium bromide, 1-Butyl-2,3-dimethylimidazolium chloride, 1-Butyl-2,3-dimethylimidazolium iodide, 490087 1-Butyl-3-methylimidazolium bromide, 1-Butyl-3-methylimidazolium chloride, 1-Butyl-3-methylimidazolium iodide, N-Butyl-3-methylpyridinium chloride, and N-Butyl-4-methylpyridinium chloride.

Other: 1-Butyl-3-methylimidazolium tricyanomethane, N-Butyl-3-methylpyridinium dicyanamide, 1-Butyl-1-methylpyrrolidinium dicyanamide, and 1-Ethyl-3-methylimidazolium hydrogensulfate.

Phosphates and Phosphinates: N-Butyl-3-methylpyridinium hexafluorophosphate, 1-Butyl-2,3-dimethylimidazolium hexafluorophosphate, 1-Butyl-3-methylimidazolium hexafluorophosphate, 1-Butyl-3-methylimidazolium hexafluorophosphate, 1-Butyl-3-methylimidazolium hexafluorophosphate, 1-Butyl-1-methylpyrrolidinium tris (pentafluoroethyl)trifluorophosphate, 1-Butyl-1-methylpyrrolidinium tris(pentafluoroethyl)trifluorophosphate, 1,3-Dimethylimidazolium dimethylphosphate, 1-Ethyl-3-methylimidazolium diethylphosphate, and Guanidinium tris (pentafluoroethyl)trifluorophosphate.

Sulfates and Sulfonates: 1-Butyl-3-methylimidazolium methanesulfonate, N-Butyl-3-methylpyridinium trifluoromethanesulfonate, 1-Butyl-2,3-dimethylimidazolium trifluoromethanesulfonate, 1-Butyl-3-methylimidazolium hydrogensulfate, 1-Butyl-3-methylimidazolium methylsulfate, 1-Butyl-3-methylimidazolium octylsulfate, 1-Butyl-3-methylimidazolium trifluoromethanesulfonate, 1-Butyl-3-methylimidazolium trifluoromethanesulfonate, 1-Butyl-3-methylimidazolium trifluoromethylsulfonate, and N-Butyl-3-methylpyridinium methylsulfate.

Ammoniums: N-Ethyl-N,N-dimethyl-2-methoxyethylammonium bis(trifluoromethylsulfonyl)imide, Ethyl-dimethyl-propylammonium bis(trifluoromethylsulfonyl)imide, Ethyl-dimethyl-propylammonium bis(trifluoromethylsulfonyl)imide, (2-Hydroxyethyl)trimethylammonium dimethylphosphate, Methyltrioctylammonium bis(trifluoromethylsulfonyl)imide, Methyltrioctylammonium trifluoroacetate, Methyltrioctylammonium trifluoromethanesulfonate, Tetrabutylammonium bis(trifluoromethylsulfonyl)imide, Tetramethylammonium bis(oxalato(2-))-borate, and Tetramethylammonium tris(pentafluoroethyl)trifluorophosphate.

Guanidiniums: Guanidinium trifluoromethanesulfonate, Guanidinium tris(pentafluoroethyl)trifluorophosphate, and Hexamethylguanidinium tris(pentafluoroethyl)trifluorophosphate.

Imidazoles: 1-Benzyl-3-methylimidazolium chloride, 1-Butyl-3-methylimidazolium methanesulfonate, 1-Butyl-2,3-dimethylimidazolium bis(trifluoromethylsulfonyl)imide, 1-Butyl-3-methylimidazolium bis(trifluoromethylsulfonyl)imide, 1-Butyl-3-methylimidazolium bromide, 1-Butyl-3-methylimidazolium chloride, 1-Butyl-3-methylimidazolium dicyanamide, 1-Butyl-3-methylimidazolium hexafluorophosphate, 1-Butyl-3-methylimidazolium hexafluorophosphate, 1-Butyl-3-methylimidazolium hexafluorophosphate, 1-Butyl-2,3-dimethylimidazolium chloride, 1-Butyl-2,3-dimethylimidazolium hexafluorophosphate, 1-Butyl-2,3-dimethylimidazolium iodide, 1-Butyl-2,3-dimethylimidazolium tetrafluoroborate, 1-Butyl-2,3-dimethylimidazolium trifluoromethanesulfonate, 2,3-Dimethyl-1-propylimidazolium bis(trifluoromethylsulfonyl)imide, 1-Ethyl-2,3-dimethylimidazolium chloride, 1-Hexyl-2,3-dimethylimidazolium chloride, 1-Hexyl-2,3-dimethylimidazolium tris (pentafluoroethyl)trifluorophosphate, and 1-(2-Hydroxyethyl)-3-methylimidazolium bis(trifluoromethylsulfonyl)imide.

Phosphoniums: Trihexyl(tetradecyl)phosphonium bis[oxalato(2-)]borate, Trihexyl(tetradecyl)phosphonium bis(trifluoromethylsulfonyl)imide, Trihexyl(tetradecyl)phosphonium tris(pentafluoroethyl)trifluorophosphate, and Trihexyl(tetradecyl)phosphonium tris(pentafluoroethyl)trifluorophosphate.

Pyridines: N-Butyl-3-methylpyridinium bromide, N-Butyl-3-methylpyridinium hexafluorophosphate, N-Butyl-3-methylpyridinium trifluoromethanesulfonate, N-Butyl-3-methylpyridinium chloride, N-Butyl-4-methylpyridinium chloride, N-Butyl-3-methylpyridinium dicyanamide, N-Butyl-3-methylpyridinium methylsulfate, N-Butyl-3-methylpyridinium tetrafluoroborate, N-Butyl-4-methylpyridinium tetrafluoroborate, and N-Butylpyridinium chloride.

Pyrrolidines: 1-Butyl-1-methylpyrrolidinium bromide, 1-Butyl-1-methylpyrrolidinium bis[oxalato(2-)]borate, 1-Butyl-1-methylpyrrolidinium bis(trifluoromethylsulfonyl)imide, 1-Butyl-1-methylpyrrolidinium bis(trifluoromethylsulfonyl)imide, 1-Butyl-1-methylpyrrolidinium bis(trifluoromethylsulfonyl)imide, 1-Butyl-1-methylpyrrolidinium chloride, 1-Butyl-1-methylpyrrolidinium dicyanamide, 1-Butyl-1-methylpyrrolidinium dicyanamide, 1-Butyl-1-methylpyrrolidinium trifluoroacetate, and 1-Butyl-1-methylpyrrolidinium trifluoromethanesulfonate.

Crown ethers are a class of cation receptor exhibiting chemical and physical properties beneficial for enhancing the dissolution of (Li/Na)₂Oₓ. These compounds are useful for complex formation with metal ions in solution. Useful crown ether cation receptors include 12-Crown-4, 15-Crown-5,18-Crown-6 and other Benzo-crown ether and Cyclohexyl-crown ether derivatives.

### Example 3

### Exemplary Solvated Electron Solutions Including Various Concentration of Metal Donor Metal Acceptor and Solvent

Various Lithium Naphthalene Tetrahydrofuran Liₙ(Naph)ₘ(THF)_{q}SES solutions were prepared as follows:

Solution 1 (1:1:12.33 solution): 12.8 g (0.1 mole) of naphthalene is added to 90 ml of dried THF under magnetic stirring in argon atmosphere. Naphtalene dissolves readily in THF. Then 0.7 g of lithium foil (0.1 mole) is a added to the solution while keeping stirring in argon. Lithium dissolves in the Naphtalene-THF solution after about 1 to 2 hours to form the SES. The SES takes a dark color. THF is added to complete 100 ml total SES volume. Solution 1 contain 1 mole/1 Li, 1 mole/1 naphthalene and 12.33 moles/1 THF, thus the 1:1:12.33 designation.

Solution 2 (2:1:12.33) Solution 2 is prepared under same conditions than solution 1, except 1.4 g of lithium was used instead of 0.7 g.

Solution 3: (1:2:12.33): Solution 3 is prepared under same conditions than solution 1, except 25.6 g of naphthalene was used instead of 12.8 g.

Solution 4: (2:2:12.33): Solution 4 is prepared under same conditions than solution 1, except 25.6 g of naphthalene was used instead of 12.8 g and 1.4 g of lithium was used instead of 0.7 g.

Solution 5: (4:2:12.33): Solution 5 is prepared under same conditions than solution 4, except 2.8 g of lithium was used instead of 1.4 g.

Solution 6 (6:3:12.33):Solution 6 is prepared under same conditions than solution 1, except 38.45 g of naphthalene was used instead of 12.8 g and 4.2 g of lithium was used instead of 0.7 g.

The solubility of naphthalene in THF at 25 C has been determined to be 6.639 moles/1 [Ref. 12] Applicant's results show that up to 2 Li moles can react with 1 mole of. Naphthalene. Accordingly a molar composition Li_{13.278}Naph_{6.639}THF_{12.33} it is expected to be achieved with the highest Li and naphthalene concentrations. The later for lithium is 13.28 mole-Li/liter-THF at 25 C. Up to about of 15 mole/liter can be achieved at higher temperatures.

Solution 7: Potassium-naphtalene-THF (2:1:12.33): Solution 7 was prepared under the same conditions than solution 1 except about 7.8 g of potassium was used instead of 0.7 g of Lithium. The solution was black in color.

### Example 4

### Exemplary Metal Organo Radical Solutions

Metal organo radical solutions can be purchased ready for use from chemicals various companies. Exemplary organo radical solutions that can be purchased comprise organolithium solutions such as Methyllithium lithium iodide complex 1.0 M in diethyl ether (CH₃ILi₂), Methyl-d₃-lithium, as complex with lithium iodide solution 0.5 M in diethyl ether (CD₃Li.LiI), Methyllithium lithium bromide complex solution (CH₃Li.BrLi), Methyllithium solution 3.0 M in diethoxymethane (CH₃Li), Methyllithium solution 1.6 M in diethyl ether CH₃Li, Methyllithium solution 3% in 2-Methyltetrahydrofuran/cumene (CH₃Li), Ethyllithium solution 0.5 M in benzene: cyclohexane (C₂H₅Li), Isopropyllithium solution 0.7 M in pentane (C₃H₇Li), 2-Thienyllithium solution 1.0 M in THF (C₄H₃LiS), Butyllithium solution 2.0 M in cyclohexane (C₄H₉Li), Butyllithium solution purum, ˜2.7 M in heptane (C₄H₉Li), Butyllithium solution 10.0 M in hexanes (C₄H₉Li), Butyllithium solution 2.5 M in hexanes (C₄H₉Li), Butyllithium solution 1.6 M in hexanes (C₄H₉Li), Butyllithium solution 2.0 M in pentane (C₄H₉Li), Butyllithium solution ˜1.6 M in hexanes (C₄H₉Li), Butyllithium solution technical, ˜2.5 M in toluene (C₄H₉Li), Isobutyllithium solution technical, ˜16% in heptane (−1.7 M) (C₄H₉Li, sec-Butyllithium solution 1.4 M in cyclohexane (C₄H₉Li), tert-Butyllithium solution purum, 1.6-3.2 M in heptanes, (C₄H₉Li), tert-Butyllithium solution 1.7 M in pentane (C₄H₉Li), tert-Butyllithium solution technical, ˜1.7 M in pentane (C₄H₉Li), Lithium acetylide ethylenediamine complex technical, ≧90% (T) (C₄H₉LiN₂), Lithium acetylide, ethylenediamine complex 90% (C₄H₉LiN₂), Lithium acetylide, ethylenediamine complex 25 wt. % slurry in toluene (C₄H₉LiN₂), (Trimethylsilyl)methyllithium solution 1.0 M in pentane (C₄H₁₁LiSi), Cyclopentadienyllithium 97% (C₅H₅Li), Lithium (trimethylsilyl)acetylide solution purum, ˜0.5 M in THF (C₅H₉LiSi), Lithium (trimethylsilyl)acetylide solution 0.5 M in THF (C₅H₉LiSi), Neopentyl lithium solution 0.6 M in cyclohexane/toluene(C₅H₁₁Li), Pentyllithium solution 2.2 M in heptane (C₅H₁₁Li), Phenyllithium solution 1.8 M in dibutyl ether (C₆H₅Li), Hexyllithium solution 2.3 M in hexane (C₆H₁₃Li), Lithium phenylacetylide solution 1.0 M in THF (C₈H₅Li), 2-(Ethylhexyl)lithium solution 30-35 wt. % in heptane (C₈H₁₇Li), Lithium tetramethylcyclopentadienide (C₉H₁₃Li), and Lithium pentamethylcyclopentadienide (C₁₀H₁₅Li). These organolithium solutions can be purchased from Sigma Aldrich and are listed in the product directory at the web page sigmaaldrich.com/chemistry/chemistry-products.html?TablePage=16245216 at the filing date of the present disclosure.

Applicant used 10M solution of butyl lithium in hexane. The solution was the diluted in various sets of experiments to make 5M, 2M and 1M solutions.

Further examples of organo radical solutions from Aldrich catalogue of organometallic compounds comprise organosilicon such as disilanes 1,1,2,2-Tetramethyldisilane 98% (C₄H₁₄Si₂), 1,2-Dimethoxy-1,1,2,2-tetramethyldisilane 97% (C₆H₁₈O₂Si₂),1,2-Diethoxy-1,1,2,2-tetramethyldisilane 97% (C₈H₂₂Si₂O₂), 1,2-Bis(2-methoxyphenyl)-1,1,2,2-tetramethyldisilane 96% (C₁₈H₂₆O₂Si₂) 1,2-Dimethyl-1,1,2,2-tetraphenyldisilane 97% (C₂₆H₂₆Si₂), Hexamethyldisilane 98% (C₆H₁₈Si₂)Hexamethyldisilane Wacker quality, ≧98.0% (GC) (C₆H₁₈Si₂), Pentamethyldisilane 97% (C₅H₁₆Si₂), silanols, methylsilanol ≧98.5% (GC) (C₃H₁₀OSi), Sodium 2-furyldimethylsilanolate C₆H₉NaO₂Si, Dimethyl(2-thienyl)silanol 97% (C₆H₁₀OSSi, tert-Butyldimethylsilanol purum, ≧98.0% (GC) (C₆H₁₆OSi), tert-Butyldimethylsilanol 99% (C₆H₁₆OSi), Triethylsilanol purum, ≧98.0% (GC) C₆H₁₆OSi, Triethylsilanol 97% C₆H₁₆OSi, (3,4-Dihydro-2H-pyran-6-yl)dimethylsilanol 95% C₇H₁₄O₂Si, Sodium dimethylphenylsilanolate hydrate 97% C₈H₁₁NaOSi.xH₂O, Dimethylphenylsilanol 95% C₈H₁₂OSi, (4-Methoxyphenyl)dimethylsilanol 96% C₉H₁₄O₂Si, Triisopropylsilanol 98% C₉H₂₂OSi, 1,4-Bis(hydroxydimethylsilyl)benzene 95% C₁₀H₁₈O₂Si₂, (N-Boc-2-pyrrolyl)dimethylsilanol 97% C₁₁H₁₉NO₃Si, Diphenylsilanediol 95% C₁₂H₁₂O₂Si, Tris(tert-butoxy)silanol packaged for use in deposition systems, 99.999% trace metals basis C₁₂H₂₈O₄Si, Tris(tert-pentoxy)silanol packaged for use in deposition systems, ≧99.99% trace metals basis C₁₅H₃₄O₄Si, Triphenylsilanol 98% C₁₈H₁₆OSi, silazanes 1,1,3,3-Tetramethyldisilazane 97% C₄H₁₅NSi₂, Hexamethyldisilazane C₆H₁₉NSi₂, Hexamethyldisilazane semiconductor grade PURANAL™ (Honeywell 17713) C₆H₁₉NSi₂, Hexamethyldisilazane puriss. p.a., for GC, ≧99.0% (GC) C₆H₁₉NSi₂, Hexamethyldisilazane purum, ≧98.0% (GC) C₆H₁₉NSi₂, Hexamethyldisilazane Wacker quality, ≧97.0% (GC) C₆H₁₉NSi₂, Hexamethyldisilazane ReagentPlus®, 99.9% C₆H₁₉NSi₂, Hexamethyldisilazane reagent grade, ≧99% C₆H₁₉NSi₂, 2,2,4,4,6,6-Hexamethylcyclotrisilazane 97% C₆H₂ᵢN₃Si₃, 1,3-Diethyl-1,1,3,3-tetramethyldisilazane ≧98.0% C₈H₂₃NSi₂, 2,4,6-Trimethyl-2,4,6-trivinylcyclotrisilazane technical, ≧90% C₉H₂₁N₃Si₃, 1,1,3,3-Tetramethyl-1,3-diphenyldisilazane 96% C₁₆H₂₃NSi₂, 1,3-Dimethyl-1,1,3,3-tetraphenyldisilazane purum, ≧98.0% (NT) C₂₆H₂₇NSi₂ Silicates Tetramethyl orthosilicate deposition grade, ≧98%, ≧99.9% trace metals basis C₄H₁₂O₄Si, Tetramethyl orthosilicate puriss., ≧99.0% (GC) C₄H₁₂O₄Si, Tetramethyl orthosilicate ≧99% C₄H₁₂O₄Si, Tetramethyl orthosilicate purum, ≧98.0% (GC) C₄H₁₂O₄Si, Tetramethyl orthosilicate 98% C₄H₁₂O₄Si, Tetramethyl-d₁₂ orthosilicate 99 atom % D C₄D₁₂O₄Si, Tetraethyl orthosilicate 99.999% trace metals basis C₈H₂₀O₄Si, Tetraethyl orthosilicate puriss., ≧99.0% (GC) C₈H₂₀O₄Si, Tetraethyl orthosilicate ReagentPlus®, ≧99% C₈H₂₀O₄Si, Tetraethyl orthosilicate reagent grade, 98% C₈H₂₀O₄Si, Tetrakis(dimethylsilyl)orthosilicate purum, ≧97.0% (GC) C₈H₂₈O₄Si₅, Tetrakis(dimethylsilyl) orthosilicate 96% C₈H₂₈O₄Si₅, Tetraallyl orthosilicate technical, ≧85% (GC) C₁₂H₂₀O₄Si, Tetrapropyl orthosilicate ≧98%, deposition grade C₁₂H₂₈O₄Si, Tetrapropyl orthosilicate 95% C₁₂H₂₈O₄Si, Tetrabutyl orthosilicate purum, ≧97.0% (GC) C₁₆H₃₆O₄Si, Tetrabutyl orthosilicate 97% C₁₆H₃₆O₄Si, Siloxanes Methoxytrimethylsilane purum, ≧97.0% (GC) C₄H₁₂OSi, 1,1,3,3-Tetramethyldisiloxane Wacker quality, ≧98.0% (GC) C₄H₁₄OSi₂, 1,1,3,3-Tetramethyldisiloxane 97% C₄H₁₄OSi₂, 2,4,6,8-Tetramethylcyclotetrasiloxane ≧99.5%, ≧99.999% trace metals basis C₄H₁₆O₄Si₄, 2,4,6,8-Tetramethylcyclotetrasiloxane technical, ≧95% (GC) C₄H₁₆O₄Si₄, 2-Chloroethoxytrimethylsilane 98% C₅H₁₃ClOSi, Pentamethyldisiloxane ≧95.0% C₅H₁₆OSi₂, 2,4,6,8,10-Pentamethylcyclopentasiloxane 96% C₅H₂₀O₅Si₅, Dimethoxy-methyl(3,3,3-trifluoropropyl)silane ≧97.0% (GC) C₆H₁₃H₃O₂Si, (Chloromethyl)-isopropoxy-dimethylsilane 97% C₆H₁₅ClOSi, (Chloromethyl)methyldiethoxysilane 97% C₆H₁₅ClO₂Si, 1,3-Bis(chloromethyl)-1,1,3,3-tetramethyldisiloxane 99% C₆H₁₆Cl₂OSi₂, Isopropoxytrimethylsilane 98% C₆H₁₆OSi, Trimethyl(propoxy)silane 98% C₆H₁₆OSi, Hexamethyldisiloxane puriss, ≧98.5% (GC) C₆H₁₈OSi₂, Hexamethyldisiloxane NMR grade, ≧99.5% C₆H₁₈OSi₂, Hexamethyldisiloxane ≧98% C₆H₁₈OSi₂, Poly(dimethylsiloxane) Dow Corning Corporation 200®fluid, viscosity 0.65 cSt (25° C.) C₆H₁₈OSi₂, Hexamethylcyclotrisiloxane 98% C₆H₁₈O₃Si₃, 1,3-Dimethyltetramethoxydisiloxane 97% C₆H₁₈O₅Si₂, 1,1,3,3,5,5-Hexamethyltrisiloxane 95% C₆H₂₀O₂Si₃, 1,1,1,3,5,5,5-Heptamethyltrisiloxane 97% C₇H₂₂O₂Si₃, 1,3-Divinyltetramethyldisiloxane 97% C₈H₁₈OSi₂, 1,3-Diethoxy-1,1,3,3-tetramethyldisiloxane 97% C₈H₂₂O₃Si₂, 1,7-Dichloro-octamethyltetrasiloxane 95% C₈H₂₄Cl₂O₃Si₄, Octamethyltrisiloxane 98% C₈H₂₄O₂Si₃, Poly(dimethylsiloxane) Dow Corning Corporation 200®fluid, viscosity 1.0 cSt (25° C.) C₈H₂₄O₂Si₃ Octamethylcyclotetrasiloxane 98% C₈H₂₄O₄Si₄, 1,1,1,3,5,7,7,7-Octamethyltetrasiloxane technical, ≧95% (GC) C₈H₂₆O₃Si₄, 2,4,6-Triethyl-2,4,6-trimethylcyclotrisiloxane 97% C₉H₂₄O₃Si₃, Tris(trimethylsiloxy)silane ≧98% C₉H₂₈O₃Si₄, 1,3-Dimethyltetravinyldisiloxane 97% C₁₀H₁₈OSi₂, Trialkylsiloxanes: Trimethoxysilane 95% C₃H₁₀O₃Si, Trimethoxysilane technical, ≧90% (GC) C₃H₁₀O₃Si, Trimethoxymethylsilane deposition grade, ≧98% C₄H₁₂O₃Si, Trimethoxymethylsilane purum, ≧98.0% (GC) C₄H₁₂O₃Si, Trimethoxymethylsilane 98% C₄H₁₂O₃Si, Trimethoxymethylsilane 95% C₄H₁₂O₃Si, Vinyltrimethoxysilane 98% and additional organosilicon that can be purchased from Sigma Aldrich and are listed in the web page www.sigmaaldrich.com/chemistry/chemistry-products.html?TablePage=16245265 at the filing date of the present application.

Further examples of metal organo radical solutions suitable in the present disclosure comprise organaluminum such as Methylaluminum dichloride solution 1.0 M in hexanes CH₃AlCl₂, Methylaluminoxane solution 10 wt. % in toluene CH₃AlO, Ethylaluminum dichloride 97% C₂H₅AlCl₂, Ethylaluminum dichloride solution 1.0 M in hexanes C₂H₅AlCl₂, Ethylaluminum dichloride solution 1.0 M in hexanes C₂H₅AlCl₂, Ethylaluminum dichloride solution 25 wt. % in toluene C₂H₅AlCl₂, Ethylaluminum dichloride solution purum, ˜1 M in hexane, Dimethylaluminum chloride 97% C₂H₆AlCl, Dimethylaluminum chloride solution 1.0 M in hexanes C₂H₆AlCl, Trimethylaluminum 97% C₃H₉Al, Trimethylaluminum packaged for use in deposition systems C₃H₉Al, Trimethylaluminum solution 2 M in chlorobenzene C₃H₉Al, Trimethylaluminum solution purum, ˜2 M in heptane C₃H₉Al, Trimethylaluminum solution 2.0 M in heptane C₃H₉Al, Trimethylaluminum solution 2.0 M in hexanes C₃H₉Al, Trimethylaluminum solution purum, ˜2 M in toluene C₃H₉Al, Trimethylaluminum solution 2.0 M in toluene C₃H₉Al, Diethylaluminum chloride 97% C₄H₁₀AlCl, Diethylaluminum chloride solution 1.0 M in heptane C₄H₁₀AlCl, Diethylaluminum chloride solution 1.0 M in hexanes C₄H₁₀AlCl, Diethylaluminum chloride solution 1.0 M in hexanes C₄H₁₀AlCl, Diethylaluminum chloride solution 25 wt. % in toluene C₄H₁₀AlCl, Diethylaluminum cyanide solution 1.0 M in toluene C₅H₁₀AlN, Diethylaluminum cyanide solution technical, ˜1 M in toluene C₅H₁₀AlN, Dimethylaluminum isopropoxide ≧99.99% metals basis, ≧95% C₅H₁₃OAl, Triethylaluminum 93% C₆H₁₅Al, Triethylaluminum solution 1.0 M in heptane C₆H₁₅Al, Triethylaluminum solution 1.0 M in hexanes C₆H₁₅Al, Triethylaluminum solution 1.0 M in hexanes C₆H₁₅Al, Triethylaluminum solution 25 wt. % in toluene C₆H₁₅Al, Diethylaluminum ethoxide 97% C₆H₁₅AlO, Diethylaluminum ethoxide solution 25 wt. % in toluene C₆H₁₅AlO, Ethylaluminum sesquichloride 97% C₆H₁₅Al₂Cl₃, Diisobutylaluminum chloride 97% C₈H₁₈AlCl, Diisobutylaluminum fluoride solution 1.0 M in hexanes C₈H₁₈AlF, Tetraethyldialuminoxane solution 1.0 M in toluene C₈H₂OAl₂O pricing, Tripropylaluminum C₉H₂₁Al, Triisobutylaluminum C₁₂H₂₇Al, Triisobutylaluminum solution 1.0 M in hexanes C₁₂H₂₇Al, Triisobutylaluminum solution 25 wt. % in toluene C₁₂H₂₇Al, Triisobutylaluminum solution 25 wt. % in toluene C₁₂H₂₇Al, Lithium diisobutyl-tert-butoxyaluminum hydride solution 0.25 M in THF/hexanes C₁₂H₂₈AlLiO, Bis (trimethylaluminum)-1,4-diazabicyclo [2.2.2]octane adduct C₁₂H₃₀Al₂N₂, Tetraisobutyldialuminoxane solution 10 wt. % in toluene C₁₆H₃₆Al₂O, Triphenylaluminum solution 1 M in dibutyl ether C₁₈H₁₅Al, Trioctylaluminum solution 25 wt. % in hexanes C₂₄H₅₁Al, and additional organoaluminum that can be purchased from Sigma Aldrich and are listed in the web page www.sigmaaldrich.com/chemistry/chemistry-products.html?TablePage=16244422 at the filing date of the present application.

Additional examples of metal organo radical solutions suitable in the present disclosure comprise organogermanium such as Dimethylgermanium dichloride 99% C₂H₆Cl₂Ge, Trimethylgermanium bromide 98% C₃H₉BrGe, Chlorotrimethylgermane 98% C₃H₉ClGe, Diethylgermanium dichloride 97% C₄H₁₀Cl₂Ge, Tetramethylgermanium 98% C₄H₁₂Ge, Phenylgermanium trichloride 98% C₆H₅Cl₃Ge, Bis(2-carboxyethylgermanium(IV) sesquioxide) 99% C₆H₁₀Ge₂O₇, Chlorotriethylgermane 96% C₆H₁₅ClGe, Triethylgermanium hydride 98% C₆H₁₆Ge, Hexamethyldigermanium(IV) technical grade C₆H₁₈Ge₂, Diphenylgermanium dichloride 95% C₁₂H₁₀Cl₂Ge, Tributylgermanium hydride 99% C₁₋₁₂H₂₈Ge, Hexaethyldigermanium(IV) 97% C₁₂H₃₀Ge₂, Triphenylgermanium chloride 99% C₁₈H₁₅ClGe, Triphenylgermanium hydride C₁₈H₁₆Ge, Hexaphenyldigermanium(IV) 97% C₃₆H₃₀Ge₂, Hexaphenyldigermoxane 97% C₃₆H₃₀Ge₂O, and additional organogermanium that can be purchased from Sigma Aldrich and are listed in the web page www.sigmaaldrich.com/chemistry/chemistry-products.html?TablePage=16251219 at the filing date of the present application.

### Example 5

### System for Hydrogen Storage from H₂ into Solvated Electron Solutions

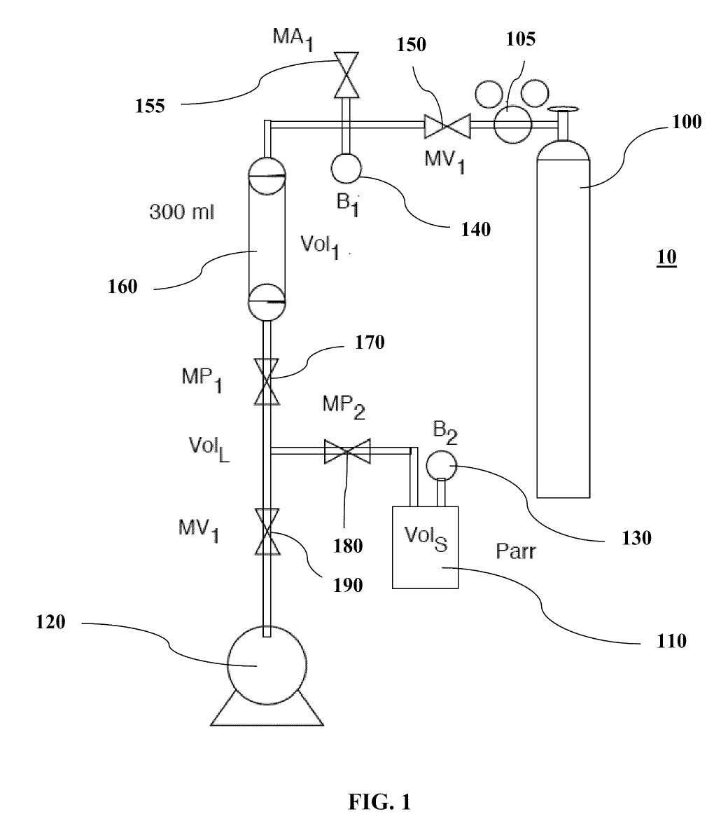

Hydrogen storage was performed using system (10) shown in the schematic illustration of FIG. 1. The system of FIG. 1 comprises a hydrogen tank (100) fluidically connected to a pressure container (110) through a gas cylinder regulator (105) through a containment space (160) and a series of valves (150), (155), (170) and (180) while pressure is detected through baratrons (130) and (140). The hydrogen tank (100), containment space (160) and pressure container (110) are also fluidically connected to a vacuum pump (120) through a valve (190). In the illustration of FIG. 1, the containment space (160) has volume V1, the section of the system comprising pressure container (110) and has a reactor volume Vs and usually includes the SES herein described; the section of the system comprised between valves (170), (180) and (190) has a volume VL.

When in operation, hydrogen is allowed into the system from hydrogen tank (100) through a valve (150) located at a section of the system where the pressure of the hydrogen into is measured by baratron (140) connected to a valve (155) to the outside air. Up to 300 ml of Hydrogen can be stored in a containment space (160). Valves (170) and (180) allow hydrogen to enter the pressure container (110) which includes SES. A baratron (130) measures changes in pressure in the pressure container. A valve (190) allows purging of the line of gas or other fluid by the vacuum pump (120) typically prior of introducing hydrogen to the reactor.

The system was initially calibrated with argon gas. Fixed amounts of hydrogen were introduced from hydrogen tank (100) to a pressure vessel (110). The hydrogen was introduced into the system through valve (150) measured by baratron (140). Hydrogen was stored in the system in a containment space (160) prior to being introduced into the pressure container (110). Before hydrogen was released into the pressure container (110), the volume inside the pressure container (110) was measured and referred to as Vol_{S}. Valves (170) and (180) controlled the release of hydrogen from the containment space (160) into the pressure container (110). A baratron (130) determined the pressure inside the pressure container (110). When hydrogen was allowed to enter the pressure container (110), a drop in pressure as measured by the baratron (130) would indicate absorption of the hydrogen by the SES or presence of leaks in preliminary experiments performed when containers are empty.

The pressure vessel (110) volume VolS is a Paar acid digestion bomb and is uncoupled at the “T” junction of VolL. After verification that no leaks were present in the system, a Teflon beaker containing the solution was placed inside the pressure vessel (110) and the volume of the Paar bomb containing argon gas from the glove box environment.

The results are illustrated in Table 2 and Table 3 below, indicating measurements performed with a V2 volume of 325 ml, with B2=0 at vacuum and B2=199 at atm. V2 is the volume of the reactor (VolS plus the volume of the line to the reactor VolL. The volume designated Voll refers to the volume of the stainless steel calibrated 300 ml volume plus the volume of the lines between valves (150), (155), and (170).

TABLE 2
System calibration

| | | | init P − final P | | V1 |
|---|---|---|---|---|---|
| initial P1V1 + 0*V2 | 5.703517588 | 5.70(V1) | | | |
| final P2(V1 + V2) | 3.060301508 | 3.06(V1 + 325) | 2.64321608 | 994.59799 | 376.28327 |
| initial | 5.653266332 | | | | |
| P1V1 + 2.6432*325 | | | | | |
| final P2(V1 + V2) | 4.442211055 | 4.44(V1 + 325) | 1.21105528 | 449.120603 | 370.8506224 |
| initial | 5.738693467 | | | | |
| P1V1 + 2.6432*325 | | | | | |
| final P2(V1 + V2) | 5.115577889 | 4.44(V1 + 325) | 0.62311558 | 218.844221 | 351.2096774 |
| initial | 5.728643216 | | | | |
| P1V1 + 2.6432*325 | | | | | |
| final P2(V1 + V2) | 5.587939698 | 4.44(V1 + 325) | 0.14070352 | 153.517588 | 1091.071429 |

The Voll was pressurized and V2 (VolS plus the line volume between (170), (180), and (190) was evacuated). Valve (170) was opened and the final baratron reading was noted. Using the gas law PV=constant, it was determined that Voll was 376 ml in the first run and 375 ml during the calibration of Table 3. 375 ml was used at volume Voll.

TABLE 3
System calibration

| | | | init P − final P | V1 | |
|---|---|---|---|---|---|
| initial P1V1 + 0*V2 | 3.190954774 | 3.19(V1) | | | |
| final P2(V1 + V2) | 1.708542714 | 1.71(V1 + 325) | 1.48241206 | 555.276382 | 374.5762712 |
| initial | 3.266331658 | | | | |
| P1V1 + 1.71*325 | | | | | |
| final P2(V1 + V2) | 2.487437186 | 4.44(V1 + 325) | 0.77889447 | 253.140704 | 325 |
| initial | 3.256281407 | | | | |
| P1V1 + 1.71*325 | | | | | |
| final P2(V1 + V2) | 2.864321608 | 4.44(V1 + 325) | 0.3919598 | 122.487437 | 312.5 |

Once the volume calibration was completed, a baseline measurement on pure THF was conducted.

In particular, 100 ml of THF solution was tested by placing the liquid in a Paar acid digestion bomb stainless steel reactor in an Ar glove box. The reactor was valved off and removed from the glove box where it could be connected to purged hydrogen gas lines. Aliquots of hydrogen were introduced to a calibrated volume from a hydrogen gas cylinder. These aliquots were then introduced to the THF containing reactor at ambient temperature (typically from 20 to 23° C. The pressure of the reactor was observed. If no drop in pressure took place, another aliquot of hydrogen was introduced to the calibrated volume at higher than previous pressure. Following the same procedures, this additional hydrogen was introduced to the reactor. This process was continued until there was evidence of hydrogen being absorbed into the liquid as indicated by a pressure drop in the reactor.

According to the above approach after hydrogen is provided into the pressure volume (V_{S}), the pressure was continually increased in continually higher pressure aliquots as long as no pressure drop could be discerned. Once the pressure began to drop over the course of several minutes, the related measurement was considered indicative of hydrogen absorption by the liquid. The gas law PV=nRT was applied in all cases to determine the extent of absorption. Given the known pressure P, the volume V and gas constant R and temperature T, the quantity absorbed n, could be calculated. This quantity was normalized to the mass of the SES containing liquid and converted to a mass % uptake as noted on the y-axis. If the pressure did not change, no hydrogen gas was absorbed. The gas pressure of the pressure volume was measured with the baratron gauge. The data show a calculation of how much more absorption took place (as determined by the pressure reading) over that of having an empty container.

The results are illustrated in Table 4 and Table 5 below, which indicate measurements performed with a Volume from cylinder valve MV1 to MV2=320 ml (called Voll), and a Volume of Line+Parr of 284 ml (called VolS). The initial vacuum settings on baratrons at 0 Kpa were the following Voll initial=1135 Open valves MP1 and MP2 605

The initial set of data in Table 4 was performed on pure THF from initial pressure aliquots. At the end of the experiment, the pressure vessel was uncoupled from the gas line apparatus and placed back into a glove box. When the pressurized vessel container was opened and the THF poured into a glass container, bubbles could be seen continually forming on the glass side walls and bottom and rising to the top of the glass container. That same solution was then used for a 2^{nd} baseline run shown in Table 5. While the THF was probably not completely free of hydrogen gas, uptake of hydrogen gas could again be seen at just above 3 bar hydrogen pressure.

TABLE 4
THF experiment #1

| | V1 | missing pv | absorbed H2 ml |
|---|---|---|---|
| initial P1V1 | 1.52 | 33 | 41.91 |
| final P2(V1 + V2) | 1.27 | | |
| initial P1V1 + 2.6432*325 | 2.02 | −0.75 | −1.305 |
| final P2(V1 + V2) | 1.74 | | |
| initial P1V1 + 2.6432*325 | 2.49 | 2.25 | 4.96125 |
| final P2(V1 + V2) | 2.205 | | |
| initial P1V1 + 2.6432*325 | 3 | 7.125 | 19.16625 |
| final P2(V1 + V2) | 2.69 | | |
| initial P1V1 + 2.6432*325 | 3 | 457.125 | 886.8225 |
| final P2(V1 + V2) | 1.94 | | |
| initial P1V1 + 2.6432*325 | 3.51 | −2.25 | −6.58125 |
| final P2(V1 + V2) | 2.925 | | |
| initial P1V1 + 2.6432*325 | 4 | −7.875 | −28.42875 |
| final P2(V1 + V2) | 3.61 | | |
| initial P1V1 + 2.6432*325 | 4.525 | −4.875 | −20.42625 |
| final P2(V1 + V2) | 4.19 | | |
| initial P1V1 + 2.6432*325 | 5.01 | −1.5 | −7.0575 |
| final P2(V1 + V2) | 4.705 | | |

TABLE 5
THF experiment #2

| | | | absorbed | cumulative | | |
|---|---|---|---|---|---|---|
| | | missing | H2 | absorbed | cumulative | |
| | V1 | pv | ml | ml | mass gm | wt % |
| initial P1V1 | 1.51 | 29.25 | 38.61 | 38.61 | 0.00344787 | 0.003917884 |
| final P2(V1 + V2) | 1.32 | | | | | |
| initial | 1.985 | −5.625 | −9.815625 | 28.794375 | 0.00257134 | 0.002921889 |
| P1V1 + 2.6432*325 | | | | | | |
| final P2(V1 + V2) | 1.745 | | | | | |
| initial | 2.505 | −9 | −20.115 | 8.679375 | 0.00077507 | 0.000880752 |
| P1V1 + 2.6432*325 | | | | | | |
| final P2(V1 + V2) | 2.235 | | | | | |
| initial | 3 | −4.125 | −11.22 | −2.540625 | −0.0002269 | −0.00025782 |
| P1V1 + 2.6432*325 | | | | | | |
| final P2(V1 + V2) | 2.72 | | | | | |
| initial | 3.58 | −4.5 | −14.6925 | −17.233125 | −0.0015389 | −0.0017488 |
| P1V1 + 2.6432*325 | | | | | | |
| final P2(V1 + V2) | 3.265 | | | | | |
| initial | 3.58 | 895.125 | 1763.39625 | 1746.16313 | 0.15593237 | 0.176882443 |
| P1V1 + 2.6432*325 | | | | | | |
| final P2(V1 + V2) | 1.97 | | | | | |
| initial | 5.01 | −15 | −58.425 | 1687.73813 | 0.15071501 | 0.170974239 |
| P1V1 + 2.6432*325 | | | | | | |
| final P2(V1 + V2) | 3.895 | | | | | |

In the illustration of Table 4 and Table 5 the pv column refers to the hydrogen that is absorbed. This value can be indicated by a simple pressure drop as indicated on the baratron gauge. In this set of data this value is expressed as pv: the pressure drop was multiplied times the volume of the entire volume. The pv value was then used for the algebra to obtain the quantities in the columns on the right.

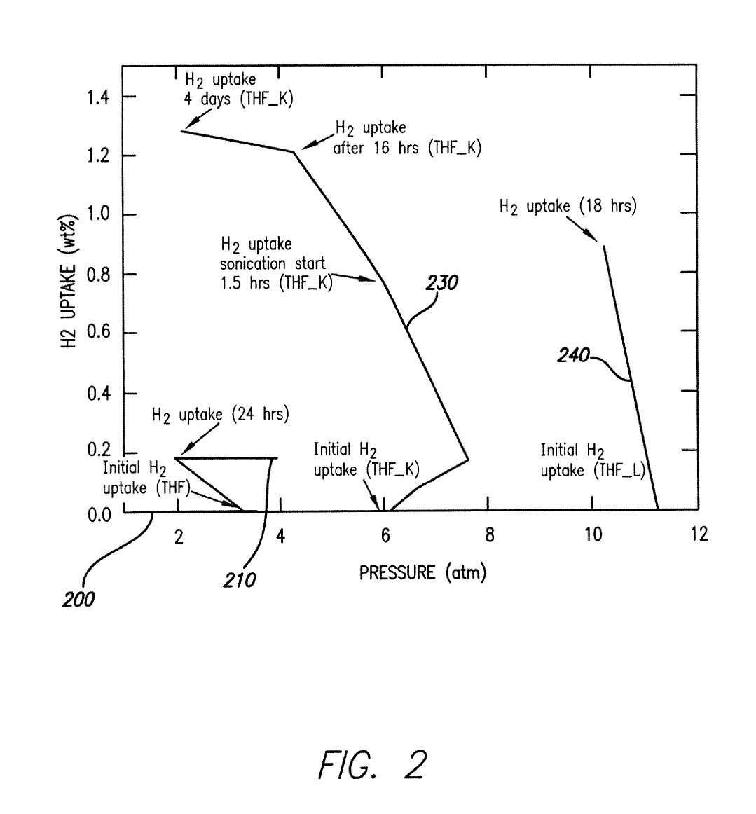

The results of the baseline experiments are also illustrated by trace (210) in the chart of FIG. 2, which show no H₂ uptake pressure decrease on the y-axis up to 3 atm. When a final pressure hydrogen above 3 atm was introduced, the pressure of the baratron gauge decreased slowly, indicating that small quantities of hydrogen gas could be absorbed into THF alone. After 24 hours, the final pressure was measured and additional hydrogen was introduced to the THF-only containing reactor, to 4 atm. No further uptake of hydrogen gas could be detected.

The results illustrated by traces (200) and (210) of the chart of FIG. 2 indicate an hydrogen uptake on the y-axis after the hydrogen pressure equilibrated and shows that at low pressures, there was no observed gas absorption. In particular, reference is made to trace (200) runs along the y-axis near zero % uptake shows that no absorption is taking place until a pressure of ˜3 atm is reached. At that point, the system pressure drops as absorption occurs as shown by trace (210). In particular, the threshold occurred at 3 atm as shown by the line designated (210) which indicates hydrogen uptake that increases to 0.18 wt %. The hydrogen uptake as described for line (210) in FIG. 2 is extrapolated from Table 4.

In the SES used in this set of experiments the solvent was THF. A skilled person will understand that pressure decrease and related hydrogen absorbance are expected to be obtained with hexane or any other solvent described herein. Additional organic compounds will further assist in the storage of hydrogen, and can include, but are not limited to, naphthalene, diphenyl, or polyaromatic hydrocarbons or organo radical as described in the present disclosure and further exemplified in the following examples.

### Example 6

### System for Hydrogen storage from H₂ in Solvated Electron Solutions including Potassium

A further set of data was detected with the system described in Example 5 using Solution 7 prepared as illustrated in Example 3 which comprises potassium in THF. The calibration of the system is the same as performed in Example 5.

In particular, 100 ml of SES in THF solutions was tested by placing the liquid in a Paar acid digestion bomb stainless steel reactor in an Ar glove box. The reactor was valved off and removed from the glove box where it could be connected to purged hydrogen gas lines. Aliquots of hydrogen were introduced to a calibrated volume from a hydrogen gas cylinder. These aliquots were then introduced to the SES and THF containing reactor at ambient temperature (typically from 20 to 23° C. The pressure of the reactor was observed. If no drop in pressure took place, another aliquot of hydrogen was introduced to the calibrated volume at higher than previous pressure. Following the same procedures, this additional hydrogen was introduced to the reactor. This process was continued until there was evidence of hydrogen being absorbed into the liquid as indicated by a pressure drop in the reactor.

With a potassium solvated electron solution, no uptake was observed until 6 atm of pressure and then the uptake was limited. At nearly 8 atm, larger quantities of hydrogen were absorbed. Some sonication of the pressure vessel aided in the uptake of hydrogen. After 16 hrs, the hydrogen uptake slowed down and the final uptake was on the order of ˜1.2 wt %. The hydrogen uptake as described for line (220) in FIG. 2 is extrapolated from Table 6.

The data illustrated in Table 6 (THF experiment 3 with K) were taken with a Volume from cylinder valve MV1 to MV2=320 ml (called Voll), and a Volume of Line+Parr of 284 ml (called VolS).

The initial vacuum settings on baratrons at 0 Kpa were the following Voll initial=1135 ml, Open valves MP1 and MP2=605 ml.

TABLE 6
THF Experiments #3 with K

| | | | missing | absorbed | cum. | Cumulative | |
|---|---|---|---|---|---|---|---|
| Time | | | pv | H2 ml | absorb. | Mass gm | Wt % |
| | initial P1V1 | 1.52 | 33 | 44.55 | 44.55 | 0.00397832 | 0.004520608 |
| | final P2(V1 + V2) | 1.35 | | | | | |
| | initial | 2.045 | −9.375 | −16.875 | 27.675 | 0.00247138 | 0.002808305 |
| | P1V1 + 2.6432*325 | | | | | | |
| | final P2(V1 + V2) | 1.8 | | | | | |
| | initial | 2.55 | −3.75 | −8.53125 | 19.14375 | 0.00170954 | 0.001942618 |
| | P1V1 + 2.6432*325 | | | | | | |
| | final P2(V1 + V2) | 2.275 | | | | | |
| | initial | 3.05 | −12.375 | −34.4025 | −15.25875 | −0.0013626 | −0.00154844 |
| | P1V1 + 2.6432*325 | | | | | | |
| | final P2(V1 + V2) | 2.78 | | | | | |
| | initial | 3.515 | −6.375 | −20.71875 | −35.9775 | −0.0032128 | −0.00365103 |
| | P1V1 + 2.6432*325 | | | | | | |
| | final P2(V1 + V2) | 3.25 | | | | | |
| | initial | 4.5 | −14.25 | −57.78375 | −93.76125 | −0.0083729 | −0.00951554 |
| | P1V1 + 2.6432*325 | | | | | | |
| | final P2(V1 + V2) | 4.055 | | | | | |
| | initial | 5.495 | −9 | −44.73 | −138.49125 | −0.0123673 | −0.01405569 |
| | P1V1 + 2.6432*325 | | | | | | |
| | final P2(V1 + V2) | 4.97 | | | | | |
| | initial | 6.495 | −16.125 | −95.94375 | −234.435 | −0.020935 | −0.02379549 |
| | P1V1 + 2.6432*325 | | | | | | |
| | final P2(V1 + V2) | 5.95 | | | | | |
| | initial | 7.49 | 148.5 | 989.7525 | 755.3175 | 0.06744985 | 0.076588856 |
| | P1V1 + 2.6432*325 | | | | | | |
| | final P2(V1 + V2) | 6.665 | | | | | |
| 16 | initial | 8.485 | 112.5 | 856.6875 | 1612.005 | 0.14395205 | 0.163314718 |
| hrs | P1V1 + 2.6432*325 | | | | | | |
| | final P2(V1 + V2) | 7.615 | | | | | |
| 1 | initial | 7.615 | 804 | 5045.1 | 6657.105 | 0.59447948 | 0.671011873 |
| week | P1V1 + 2.6432*325 | | | | | | |
| | final P2(V1 + V2) | 6.275 | | | | | |
| sonication and 1.5 hr | | | | | | | |
| | initial | 6.275 | 165 | 990 | 7647.105 | 0.68288648 | 0.770031856 |
| | P1V1 + 2.6432*325 | | | | | | |
| | final P2(V1 + V2) | 6 | | | | | |
| 18 | initial | 6 | 1020 | 4386 | 12033.105 | 1.07455628 | 1.206356025 |
| hrs | P1V1 + 2.6432*325 | | | | | | |
| | final P2(V1 + V2) | 4.3 | | | | | |
| 4 | initial | 4.3 | 352.5 | 740.25 | 12773.355 | 1.1406606 | 1.279618744 |
| days | P1V1 + 2.6432*325 | | | | | | |
| | final P2(V1 + V2) | 2.1 | | | | | |

Hydrogen uptake with potassium in hydrogen is illustrated by trace (230) in the chart of FIG. 2, which show no H2 uptake pressure decrease on the y-axis up to nearly 8 atm. When a final pressure hydrogen above nearly 8 atm was introduced, the pressure of the baratron gauge decreased slowly, indicating that small quantities of hydrogen gas could be absorbed into the potassium and THF mixture. After 4 days, the final pressure was measured and additional hydrogen was introduced to the THF-only containing reactor, to around 2 atm.

### Example 7

### System for Hydrogen Storage from H₂ in Solvated Electron Solutions including Lithium

A further set of data was detected with the system described in Example 5 using Solution 2 prepared as illustrated in Example 3 which comprises the alkali metal lithium in an THF. The calibration of the system is the same as performed in Example 5.

A further set of data was detected with the system described in Example 5 using Solution 7 prepared as illustrated in Example 3.

Li:Naphthalene:THF in molar concentrations (1:1:2) is the best experimental result in terms of dissolving Li. Higher Li concentration with Li:Naphthalene (2:1:12) and (2:1:3) did result in a certain coagulation of the solution into a solid.

With a lithium solvated electron solution, over 11 atm of pressure was required before any uptake was observed. The overall uptake was slow and the measurements were stopped after 18 hours. The hydrogen uptake as described for line (230) in FIG. 2 is extrapolated from Table 6.

The data illustrated in Table 7 (THF experiment 3 with K) were taken with a Volume from cylinder valve MV1 to MV2=320 ml (called Voll), and a Volume of Line+Parr of 284 ml (called VolS).

The initial vacuum settings on baratrons at 0 Kpa were the following Voll initial=1135 ml, Open valves MP1 and MP2=605 ml.

TABLE 7
THF Experiments #3 with Li

| | | missing pv | absorbed H2 ml | | | |
|---|---|---|---|---|---|---|
| initial | 1.51 | 29.25 | 38.75625 | 38.75625 | 0.00346093 | 0.003932724 |
| P1V1 | | | | | | |
| final P2(V1 + V2) | 1.325 | | | | | |
| initial | 2.02 | 2.625 | 4.606875 | 43.363125 | 0.00387233 | 0.004400178 |
| P1V1 + 2.6432*325 | | | | | | |
| final P2(V1 + V2) | 1.755 | | | | | |
| initial | 2.49 | −0.375 | −0.830625 | 42.5325 | 0.00379815 | 0.004315896 |
| P1V1 + 2.6432*325 | | | | | | |
| final P2(V1 + V2) | 2.215 | | | | | |
| initial | 3 | −2.625 | −7.11375 | 35.41875 | 0.00316289 | 0.003594069 |
| P1V1 + 2.6432*325 | | | | | | |
| final P2(V1 + V2) | 2.71 | | | | | |
| initial | 3.505 | −1.875 | −6.01875 | 29.4 | 0.00262542 | 0.002983343 |
| P1V1 + 2.6432*325 | | | | | | |
| final P2(V1 + V2) | 3.21 | | | | | |
| initial | 3.995 | −2.625 | −9.725625 | 19.674375 | 0.00175692 | 0.001996462 |
| P1V1 + 2.6432*325 | | | | | | |
| final P2(V1 + V2) | 3.705 | | | | | |
| initial | 5.03 | −124.125 | −588.3525 | −568.67813 | −0.050783 | −0.05774123 |
| P1V1 + 2.6432*325 | | | | | | |
| final P2(V1 + V2) | 4.74 | | | | | |
| initial | 5.975 | −1.875 | −10.340625 | −579.01875 | −0.0517064 | −0.05879179 |
| P1V1 + 2.6432*325 | | | | | | |
| final P2(V1 + V2) | 5.515 | | | | | |
| initial | 6.505 | −0.75 | −4.60125 | −583.62 | −0.0521173 | −0.05925926 |
| P1V1 + 2.6432*325 | | | | | | |
| final P2(V1 + V2) | 6.135 | | | | | |
| initial | 7.5 | −1.125 | −7.86375 | −591.48375 | −0.0528195 | −0.06005821 |
| P1V1 + 2.6432*325 | | | | | | |
| final P2(V1 + V2) | 6.99 | | | | | |
| initial | 8.67 | −6 | −48.3 | −639.78375 | −0.0571327 | −0.06496569 |
| P1V1 + 2.6432*325 | | | | | | |
| final P2(V1 + V2) | 8.05 | | | | | |
| initial | 9.3 | 0.75 | 6.6225 | −633.16125 | −0.0565413 | −0.06429279 |
| P1V1 + 2.6432*325 | | | | | | |
| final P2(V1 + V2) | 8.83 | | | | | |
| initial | 10.535 | −2.625 | −25.9875 | −659.14875 | −0.058862 | −0.06693339 |
| P1V1 + 2.6432*325 | | | | | | |
| final P2(V1 + V2) | 9.9 | | | | | |
| initial | 12.12 | −16.5 | −186.6975 | −845.84625 | −0.0755341 | −0.08590791 |
| P1V1 + 2.6432*325 | | | | | | |
| final P2(V1 + V2) | 11.315 | | | | | |
| initial | 12.12 | 946.875 | 9696 | 8850.15375 | 0.79031873 | 0.890095611 |
| P1V1 + 2.6432*325 | | | | | | |
| final P2(V1 + V2) | 10.24 | | | | | |
| 16 hrs | | | | | | |

Hydrogen uptake with lithium in hydrogen is illustrated by trace (240) in the chart of FIG. 2, which show no H2 uptake pressure decrease on the y-axis up to nearly 11 atm. When a final pressure hydrogen above nearly 11 atm was introduced, the pressure of the baratron gauge decreased slowly, indicating that small quantities of hydrogen gas could be absorbed into the potassium and THF mixture. After 18 hours, the final pressure was measured and additional hydrogen was introduced to the THF-only containing reactor, to around 10 atm.

### Example 8

### Hydrogen Release from Metal-Hydride Organic Complex Comprised in Solvated Electron Solutions

The hydrogen stored in the SES described in Examples 6 and 7 can be released from the metal-hydride organic complex within the SES according to procedure herein exemplified.

Suitable temperatures are in the range of the melting point and the boiling point of the solvent. In the case of THF, these temperatures are −108.4 C and 66 C, respectively. It is expected that both temperatures will change because of the SES (ORM) formation. Basically the melting point of THF-based SESs should be below −108.4 C and it boiling point should be above 66 C. These temperature data are not available to us today and cannot be found in the open literature. In THF based SESs, the more preferred temperature range is −50 C to +50 C and even more preferred is: −30 C to +40 C.

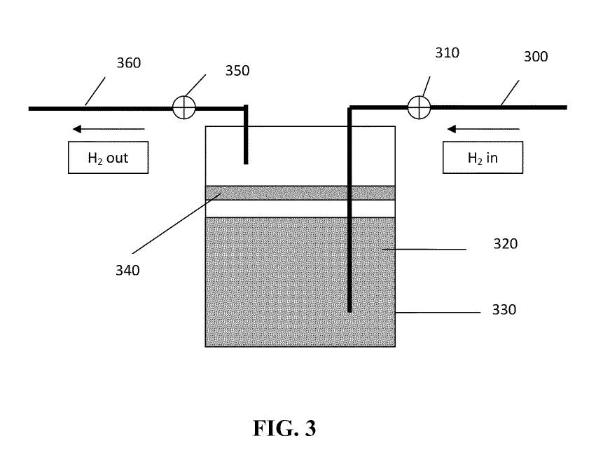

THF and other organic solvents can be mixed with Hydrogen during generation. It is proposed to use a ceramic membrane that is selectively permeable to hydrogen to allow physical separation between hydrogen and solvent molecules. For example, such membranes are described in the Gavalas et al. references [Ref. 13] and [Ref. 14] each of which is herein incorporated by reference in its entirety. A schematic drawing of a hydrogen storage and generation reactor is reported in FIG. 3.

In particular in the illustration of FIG. 3, (300): Hydrogen in pipe, (310): Hydrogen in stopper, (320): solvated electron solution or Metal Organic Radical, (330): hydrogen storage reactor, (340): hydrogen selective permeable membrane, (350): hydrogen out stopper and (360) hydrogen out pipe.

In experiments performed in connection release of hydrogen from LiH, 180KJ/mol H₂ is required. The samples were heated to 900° C.

### Example 9

### Hydrogen Storage and Release in Solvated Electron Solutions and Organometallic Solutions

H2 storage can be performed in one or in multi-step process. Pipe (300) in FIG. 3 is connected to a hydrogen tank and stopper (310) is open while stopper (350) is closed. In the 1-step process, the SES or organometallic solutions containing reactor is filled with hydrogen to some pressure P1. After hydrogen reacts with the SES or the organometallic solutions the pressure stabilizes to P2<P1. In the multi-step process, more hydrogen is added after pressure reaches an equilibrium around P2, up to for example P1, then hydrogen is allowed to react again with the SES/organometallic solutions after which an equilibrium pressure P3 is reached. The process can repeated until hydrogen saturation at P1 for example.

Hydrogen can be released either from for example initial pressure P2 (1-step) or P1 (multi-step) once the hydrogen out stopper (element (150) in FIG. 3) and stopper (310) is closed.

### Example 10

### Hydrogen Generation in Solvated Electron Solutions

SES containing metal-hydrides organic complex and water or alcohol can be stored in two different compartments and mixed under controlled atmospheric conditions to produce hydrogen.

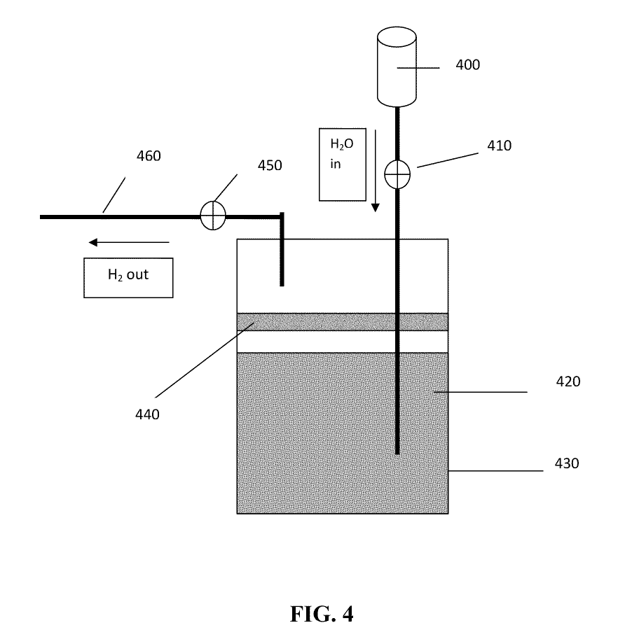

In particular, 10 cm3 of lithium-naphtalene-THF SES (solution 1 (1:1:12.33) of Example 3) was introduced in a glass reactor as schematically represented in FIG. 4 in a glove box filled with argon.

In the schematic illustration of FIG. 4, the reactor comprise (400): water (alcohol) reservoir, (410): water stopper, (420): solvated electron solution or Metal Organic Radical, (430): hydrogen storage reactor, (440): hydrogen selective permeable membrane, (450): hydrogen out stopper and (460): hydrogen out pipe.

No hydrogen selective permeable membrane (440) was used. A magnetic stirrer was introduced in the SES (420), then on the top of the reactor a system comprising: i/a conical rubber based and hermetical cap provided with two cylindrical chimneys, ii/a water (alcohol) introduction system comprising a reservoir (400), a stopper (410) and a pipe (415). Pipe (415) was hermetically passed inside the first cap chimney. Stopper (410) was closed, iii/a hydrogen exhaust system comprising a stopper (450) and an exhaust pipe (460). Exhaust pipe (460) was hermetically passed inside the second cap chimney and stopper (450) was closed.

The reactor system was then taken out the glove box and exposed to the ambient air atmosphere. Reservoir (400) was filled with water. Under strong magnetic stirring, water was very slowly and carefully introduced owing to stopper (410), while keeping stopper (450) closed. This was immediately followed by gas bubbles formation resulting from reaction between the SES and water. Stopper (410) was closed and then a match flame was presented at exhaust pipe (460) terminal, then stopper (450) was carefully open. A flame can be seen at exhaust gas terminal even after the match was extinguished. Occasionally a brief light sound could be heard when the match flame was put close to the exhaust pipe terminal. A flame and a light and brief sound are characteristic of hydrogen controlled combustion in air. In fact the lack of oxygen inside the reactor prevents critical explosion conditions from taking place.

A similar experiment than the one described above was carried out using ethanol instead of water. Similar results were achieved in particular hydrogen formed.

### Example 11

### Hydrogen Storage and Release in Organometallic Solutions

100 ml of 1M solution of butyllithium in hexane was used is the reactor of FIG. 3. The reactor was pressured with hydrogen to about 10 atm while maintaining stopper 350 closed. Then stopper 310 was closed. The pressure in the reactor decreased gradually indicating hydrogen was stored in the MOR solution. Calculated amounts of hydrogen stored is in the range 3% to 5% per weight.

Hydrogen was generated from the MOR solution by opening stopper 350 following by a drop in pressure in the reactor.

### Example 12

### Hydrogen Generation in Organometallic Solutions

In a first set of experiments 100 ml of 1M solution of butyllithium in hexane was used is the reactor of FIG. 4. Reservoir 400 was filled with water. The MOR solution was stirred magnetically. Water was slowly introduced by opening stopper 400. Hydrogen bubbles immediately appeared and evidenced by the flame test as in Example 10.

In a second set of experiments, 100 ml of 1M solution of butyllithium in hexane was used is the reactor of FIG. 4. Reservoir 400 was filled with ethanol. The MOR solution was stirred magnetically. Ethanol was slowly introduced by opening stopper 400. Hydrogen bubbles immediately appeared and evidenced by the flame test as in Example 10.

In summary, in some embodiments of the present disclosure a hydrogen storage and/or generation arrangement and compositions are described comprising an electron donor and an electron acceptor in a suitable solvent and related methods and systems to store and/or generate hydrogen.

The examples set forth above are provided to give those of ordinary skill in the art a complete disclosure and description of how to make and use the embodiments of the arrangements, devices, compositions, systems and methods of the disclosure, and are not intended to limit the scope of what the inventors regard as their disclosure. All patents and publications mentioned in the specification are indicative of the levels of skill of those skilled in the art to which the disclosure pertains.

The entire disclosure of each document cited (including patents, patent applications, journal articles, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually. However, if any inconsistency arises between a cited reference and the present disclosure, the present disclosure takes precedence.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure claimed Thus, it should be understood that although the disclosure has been specifically disclosed by preferred embodiments, exemplary embodiments and optional features, modification and variation of the concepts herein disclosed can be resorted to by those skilled in the art, and that such modifications and variations are considered to be within the scope of this disclosure as defined by the appended claims.

It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

When a Markush group or other grouping is used herein, all individual members of the group and all combinations and possible subcombinations of the group are intended to be individually included in the disclosure. Every combination of components or materials described or exemplified herein can be used to practice the disclosure, unless otherwise stated. One of ordinary skill in the art will appreciate that methods, device elements, and materials other than those specifically exemplified can be employed in the practice of the disclosure without resort to undue experimentation. All art-known functional equivalents, of any such methods, device elements, and materials are intended to be included in this disclosure. Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this disclosure. The disclosure illustratively described herein suitably can be practiced in the absence of any element or elements, limitation or limitations which is not specifically disclosed herein.

A number of embodiments of the disclosure have been described. The specific embodiments provided herein are examples of useful embodiments of the disclosure and it will be apparent to one skilled in the art that the disclosure can be carried out using a large number of variations of the devices, device components, methods steps set forth in the present description. As will be obvious to one of skill in the art, methods and devices useful for the present methods can include a large number of optional composition and processing elements and steps.

In particular, it will be understood that various modifications may be made without departing from the spirit and scope of the present disclosure. Accordingly, other embodiments are within the scope of the following claims.

### REFERENCES

[1] P. P. Edwards, Adv. Inorg. Chem. 1982, 25, 135-185.
[2] P. P. Edwards, Nature 1988, 331, 564-565.
[3] P. P. Edwards, C. N. R. Rao, N. Kumar, A. S. Alexandrov, Chem Phys Chem 2006, 7, 2015-2021.
[4] W. Weyl, Ann. Phys. 1863, 197, 601-612.
[5] C. A. Kraus, J. Am. Chem. Soc. 1908, 30, 1323-1344.
[6] R. A. Ogg Jr., Phys. Rev. 1946, 69, 668-669.
[7] F. A. Uribe, K. W. Samkow, A. F. Sammell, J. Electrochem. Soc. 1989, 139, 3558-3565
[8] R. Yazami, U.S. patent application Ser. No. 12/612,409, Nov. 4, 2009
[9] Q-S Li, Z-M Yi, M-G Su and X-F Sun, J. Chem. Eng. Data, 2008, 53, 2701-2703
[10] S. Hayama; J. C. Wasse, N. T. Skipper, J. K. Walters, Molecular Physics, 2001, 99, 779-786(8)
[11] S. D. Beattie, D. M. Manolescu, S. L. Blair, J. Electrochem. Soc., 156 1 A44-A47, 2009
[12] S. Li, Z. M. Yi, M. G. Su and X. F Sun J. Chem Eng Data 2008 53, 2701-2703.
[13] B. S. Kang and G. R. Gavalas Ind. Eng. Chem. Res. 2002, 41, 3145-3150
[14] R. Gavalas Ind. Eng. Chem. Res. 2008, 47, 5797-5811

What is claimed is:

1. A hydrogen storage arrangement comprising:
an electron donor and an electron acceptor in a solvent, the electron donor comprising an electron donor metal and the electron acceptor comprising a polycyclic aromatic hydrocarbon and/or an organo radical,
wherein the electron donor metal comprises an alkali metal, an alkali earth metal, a lanthanide metal, a metal of the boron group, a metalloid and/or an alloy thereof; and
wherein at least a portion of the electron donor comprising the electron donor metal is dissolved in the solvent, thereby generating chemical species capable of reacting with hydrogen to store hydrogen in the solvent.

2. The hydrogen storage arrangement of claim 1, wherein the electron acceptor comprises a polycyclic aromatic hydrocarbon and the chemical species comprise an electron donor metal ion and a solvated electron.

3. The hydrogen storage arrangement of claim 2, wherein the electron donor metal M, the polycyclic aromatic hydrocarbon PAH and the solvent Solv are comprised in a molar ratio of about Mₙ(PAH)ₘ(Solv.)_{q}, wherein in m, n and q are as follows about 0.1<n<about 15, about 0.075<m<about 7.5, about 1<q<about 50.

4. The hydrogen storage arrangement of claim 2, wherein the polycyclic aromatic hydrocarbon is a polycyclic aromatic hydrocarbon of formula
Cₐ₍₁₋ₓ₎AₐₓH_{b}, (I)
wherein A is Si, B and/or N, 0<x<1, and a and b are stoichiometric coefficients having a ratio b/a 0≦b/a≦0.8.

5. The hydrogen storage arrangement of claim 1, wherein the electron donor comprises one or more alkali metals, the polycyclic aromatic hydrocarbon comprises one or more of naphthalene, anthracene, and pyrene and the solvent comprises tetrahydrofuran.

6. The hydrogen storage arrangement of claim 1, wherein the alkali metal comprise Lithium and/or Potassium.

7. The hydrogen storage arrangement of claim 1, wherein the electron acceptor comprises one or more organoradicals and the chemical species comprise one or more organometals.

8. The hydrogen storage arrangement of claim 7, wherein the electron donor metal, the one or more organoradicals and the solvent are comprised in a molar ratio of Mₙ(OR)ₘ, wherein in m and n have are as follows about 1<n<6, about 0.1<m<about 10

9. The hydrogen storage arrangement of claim 1, further comprising hydrogen, the hydrogen reacting with the chemical species thereby providing a metal hydride complex comprised in the solvent.

10. A method to store hydrogen in a hydrogen storage arrangement, the method comprising contacting hydrogen with the hydrogen storage arrangement of claim 1,
the contacting performed for a time and under conditions to allow reaction of the hydrogen with the chemical species in the solvent of the arrangement to store the reacted hydrogen in the solvent.

11. The method of claim 10 wherein the hydrogen storage arrangement has a hydrogen storage arrangement pressure, the hydrogen has a hydrogen pressure and the contacting is performed with a hydrogen pressure substantially higher than the hydrogen storage arrangement pressure.

12. The method of claim 11, wherein the hydrogen pressure is comprised in a range of from about 1 to about 200 atm.

13. The method of claim 11, wherein the hydrogen pressure is comprised in a range of from about 5 to about 100 atm.

14. The method of claim 11, wherein the hydrogen pressure is comprised in a range of from about 10 to about 50 atm.

15. The method of claim 10, wherein the contacting is performed in a single step.

16. The method of any claim 10, wherein the contacting is performed in more than one steps, wherein in each step the hydrogen pressure is a hydrogen step pressure and the hydrogen arrangement pressure is a hydrogen storage arrangement step pressure and wherein the hydrogen step pressure and a hydrogen storage arrangement step pressure are substantially maintained or substantially increased from one step to another.

17. The method of any one of claim 10, wherein the contacting is performed at a substantially constant temperature.

18. A hydrogen storage arrangement obtainable by the method according to claim 10.

19. A method to provide a hydrogen storage arrangement, the method comprising contacting an electron donor and an electron acceptor in a solvent,
the electron donor comprising an electron donor metal and the electron acceptor comprising a polycyclic aromatic hydrocarbon and/or an organo radical,
wherein the electron donor metal comprises an alkali metal, an alkali earth metal, a lanthanide metal, a metal of the boron group, a metalloid and/or an alloy thereof; and
wherein the contacting is performed to allow at least a portion of the electron donor comprising the electron donor metal to be dissolved in the solvent, thereby generating chemical species capable of reacting with hydrogen to store hydrogen in the solvent.

20. The method of claim 19, further comprising contacting the chemical species with hydrogen to form a metal hydride complex within the solvent.

21. A system to provide a hydrogen storage arrangement, the system comprising
an electron donor comprising an electron donor metal, the electron donor metal comprising an alkali metal, an alkali earth metal, a lanthanide metal, a metal of the boron group, a metalloid and/or an alloy thereof;
an electron acceptor comprising a polycyclic aromatic hydrocarbon and/or an organo radical; and
a solvent for simultaneous combined or sequential use in the method of claim 19 or 20.

22. A method to release hydrogen from a hydrogen storage arrangement, the method comprising
providing the hydrogen storage arrangement of claim 9 at a hydrogen storage arrangement pressure and decreasing the hydrogen storage arrangement pressure to release hydrogen.

23. A hydrogen generating arrangement, comprising
an electron donor and an electron acceptor provided in a solvent, the electron donor comprising an electron donor metal and the electron acceptor comprising a polycyclic aromatic hydrocarbon and/or an organoradical,
wherein the electron donor metal comprises an alkali metal, an alkali earth metal, a lanthanide metal a metal of the boron group, a metalloid and/or an alloy thereof; and
wherein the electron donor metal and the electron acceptor are capable to react with the compound comprising a labile proton to generate hydrogen.

24. A method to generate hydrogen, the method comprising
contacting the hydrogen generating arrangement of claim 23 with a compound comprising a labile proton,
the contacting performed for a time and under condition to allow reaction of the electron donor metal and the electron acceptor with water or the organic molecule comprising a labile proton to generate hydrogen.

25. A system to generate hydrogen, the system comprising at least two of
an electron donor and an electron acceptor provided in a solvent, the electron donor comprising an electron donor metal and the electron acceptor comprising a polycyclic aromatic hydrocarbon and/or an organoradical, the electron donor metal comprising an alkali metal, an alkali earth metal, a lanthanide metal, a metal of the boron group, a metalloid and/or an alloy thereof; and
one or more organic molecules comprising a labile proton
for simultaneous combined or sequential use in the method of claim 24.

26. A method to store hydrogen in a suitable solvent, the method comprising
contacting hydrogen with a solvent for a time and under condition to allow reaction of the hydrogen with the solvent,
wherein the solvent is capable to dissolve at least a portion of an electron donor comprising an electron donor metal suitable in a solution further comprising an electron acceptor, wherein the electron donor comprises an electron donor metal which comprises an alkali metal, an alkali earth metal, a lanthanide metal, a metal of the boron group, a metalloid and/or an alloy thereof, and wherein the electron acceptor comprises a polycyclic aromatic hydrocarbon and/or an organo radical.

27. A solution comprising hydrogen, obtainable by the method of claim 26.

28. A method to release hydrogen from a solution, the method comprises providing the solutions comprising hydrogen of claim 27 at a starting pressure and decreasing the starting pressure to release hydrogen.
